(19) United States
(12) Patent Application Publication
(10) Pub. No.: US 2023/0391168 A1
(43) Pub. Date: Dec. 7, 2023

(54) VEHICLE GLASS

(71) Applicant: AGC Inc., Tokyo (JP)

(72) Inventors: Yuukou MINAMIYA, Tokyo (JP); Kenji AOKI, Fukushima (JP)

(73) Assignee: AGC Inc., Tokyo (JP)

(21) Appl. No.: 18/235,447

(22) Filed: Aug. 18, 2023

Related U.S. Application Data
(63) Continuation of application No. PCT/JP2022/005751, filed on Feb. 14, 2022.

(30) Foreign Application Priority Data
Feb. 19, 2021 (JP) 2021-025595

(51) Int. Cl. B60J 1/00; C03C 17/36

(52) U.S. Cl. CPC B60J 1/00; C03C 17/3607; C03C 17/3644; C03C 17/3681; C03C 17/3668; C03C 2217/23; C03C 2217/256

(57) ABSTRACT

A glass for a vehicle, includes: a glass plate; a ceramic color layer formed on a surface of the glass plate; and a conductive layer formed on a surface of the ceramic color layer, the conductive layer including silver, in which the ceramic color layer is a sintered layer including a glass frit and a pigment, the glass frit includes Bi, a lead-free solder layer is formed on at least a partial region of a surface of the conductive layer including silver, and a Bi/Ag mass ratio in an outermost surface of the conductive layer including silver is less than 0.10.

### CROSS-REFERENCE TO RELATED APPLICATIONS

This is a bypass continuation of International Patent Application No. PCT/JP2022/005751, filed on Feb. 14, 2022, which claims priority to Japanese Patent Application No. 2021-025595, filed on Feb. 19, 2021. The contents of these applications are hereby incorporated by reference in their entireties.

### TECHNICAL FIELD

The present invention relates to a glass for a vehicle.

### BACKGROUND ART

In a glass for a vehicle such as an automobile, a ceramic color layer which is a colored opaque layer or a conductive layer may be formed at a peripheral edge portion of a glass plate.

By forming the ceramic color layer at the peripheral edge portion of the glass plate, it is possible to prevent a urethane sealant or the like which adheres to and holds the glass plate and a body of the automobile from being deteriorated by ultraviolet, and it is possible to prevent the conductive layer such as an antenna or a heating wire formed at the peripheral edge portion of the glass plate or a mounted component such as a mirror base or a bracket adhered to the glass plate from being visually recognized from the outside of the automobile.

The conductive layer is formed for the purpose of forming an antenna, a circuit wiring, a heating wire, a power supply wiring, and the like. The conductive layer needs to have a low resistance, and is generally a conductive layer containing silver.

In the case where the conductive layer containing silver is formed on a surface of the ceramic color layer, there is a method in which a paste-like ceramic color composition serving as the ceramic color layer and a conductive paste containing silver are overprinted and baked. However, a phenomenon in which the silver in the conductive paste containing silver passes through the ceramic color layer, that is, so-called migration is likely to occur during baking. In the case where the silver reaches the surface of the glass plate due to the migration and becomes a silver colloid, a phenomenon of developing brown or the like is observed. The color development by the silver colloid not only deteriorates a concealing effect, which is the purpose of the ceramic color layer, but also emphasizes the presence of the conductive layer, the mounted component, and the like, and thus the appearance is impaired.

On the other hand, Patent Literature 1 discloses that a melting point of a Bi₂O₃—SiO₂—B₂O₃-based lead-free glass can be lowered without containing an alkali oxide by simultaneously blending specific amounts of BaO and MgO. By blending powders of the glass of which the melting point is lowered as a glass component of the ceramic color composition, the migration of the silver can be prevented.

While the interest in the environment is increasing in the world, a solder used at the time of connecting a conductive wire, a metal terminal, or the like to a conductive layer is changing from a leaded solder to a lead-free solder, based on the End-of Life Vehicles Directive (ELV) or the like. The lead-free solder is a solder having a lead content of 0.1 mass % or less.

With the use of the lead-free solder, there have been some cases where the properties that are satisfied without any problem in the use of a leaded solder in the related art are not satisfied. Examples of the properties that are not satisfied include a glass strength, a moisture resistance, a peel strength due to a poor solder wettability, and heat cycle characteristics.

In the case of using the leaded solder, in order to secure a connection strength of a terminal, a method is known in which a low-melting-point solder is thinly applied to a surface of a conductive layer in advance with an iron or the like, and the terminal is soldered thereon. Accordingly, the peel strength of the terminal can be kept high regardless of the solder wettability of the surface of the conductive layer.

However, the low-melting-point solder is limited to the leaded solder containing lead, and it is difficult to lower the melting point of the lead-free solder in terms of composition.

In addition, the lead-free solder is inferior in a solder wettability to the leaded solder. The reasons are considered to be as follows: (i) due to the high melting point, the solder wettability decreases in a case of the same operation temperature as that in the related art; (ii) a surface tension of an eutectic other than bismuth (Bi) added instead of lead is larger than that of an Sn—Pb eutectic; (iii) Bi or indium (In) added instead of lead is less likely to be reduced and removed, and the solder wettability decreases; and (iv) the electrode potential is high, and dissolution and removal of an oxide film on a surface of the lead-free solder is less likely to occur due to the difficulty in occurrence of contact corrosion caused by proximity of a potential to a joining base material.
Patent Literature 1: JP2008-266056A

### SUMMARY OF INVENTION

Therefore, an object of the present invention is to provide a glass for a vehicle having an excellent solder wettability, in particular, an excellent solder wettability to a lead-free solder.

As a result of intensive studies by the present inventors, it has been found that, in a glass for a vehicle in the related art that includes a ceramic color layer and a conductive layer containing silver on or above a surface of a glass plate, not only migration of the conductive layer containing silver to the ceramic color layer but also migration of a glass frit constituting the ceramic color layer to the conductive layer are more likely to occur as a temperature becomes higher in a firing temperature region.

In the case where a glass phase in the glass frit floats to the outermost surface of the conductive layer containing silver due to the migration, the solder wettability of the surface of the conductive layer is inhibited. In the case where the solder wettability is inhibited and the adhesiveness is poor, when the lead-free solder is used, cracking of the glass due to stress concentration or peeling of the ceramic color layer easily occurs. In addition, a weather resistance, that is, a moisture resistance, peeling of the ceramic color layer and cracking of the glass after a heat cycle test are also problems. The reason is that the lead-free solder is harder than the leaded solder.

In the case where the migration of the glass frit constituting the ceramic color layer to the conductive layer can be prevented, a decrease in a solder wettability due to the migration can be prevented, and an excellent solder wettability of the glass for a vehicle can be achieved. That is, the above problems can be solved by reducing the amount of components derived from the glass frit on the outermost surface of the conductive layer containing silver.

As described above, the present invention relates to the following (1) to (15).

(1) A glass for a vehicle, including:
a glass plate;
a ceramic color layer formed on a surface of the glass plate; and
a conductive layer formed on a surface of the ceramic color layer, the conductive layer including silver, in which
the ceramic color layer is a sintered layer including a glass frit and a pigment,
the glass frit includes Bi,
a lead-free solder layer is formed on at least a partial region of a surface of the conductive layer including silver, and
a Bi/Ag mass ratio in an outermost surface of the conductive layer including silver is less than 0.10.

(2) The glass for a vehicle according to item (1), in which a migration amount represented by a product of a mass concentration of oxygen (O) in the outermost surface of the conductive layer including silver and a thickness of the conductive layer including silver is 75%·μm or less.

(3) The glass for a vehicle according to item (1) or (2), in which the conductive layer including silver includes a crystallized region derived from the glass frit.

(4) The glass for a vehicle according to any one of items (1) to (3), in which an SiO₂/Bi₂O₃ mass ratio in the ceramic color layer is 0.3 to 1.0.

(5) The glass for a vehicle according to any one of items (1) to (4), in which the ceramic color layer further includes a filler.

(6) The glass for a vehicle according to item (5), in which the filler includes at least one selected from the group consisting of cordierite, zircon, and silica.

(7) The glass for a vehicle according to any one of items (1) to (6), in which the ceramic color layer has a thickness of less than 15 μm, and
contents of Na₂O, K₂O, and Bi₂O₃ satisfy a relation of {(Na₂O+K₂O)/Bi₂O_{3}<0.20} in an outermost surface of the ceramic color layer after a moisture resistance test performed under conditions of 80° C. and a humidity of 96% RH for 500 hours.

(8) The glass for a vehicle according to any one of items (1) to (7), in which the ceramic color layer has a thermal expansion coefficient at 50° C. to 350° C. of 60×10⁻⁷/° C. to 77×10⁻⁷/° C.

(9) The glass for a vehicle according to any one of items (1) to (8), in which the glass frit has a softening point Ts of 500° C. to 580° C.

(10) The glass for a vehicle according to any one of items (1) to (9), in which a 0.1% breaking strength in a Weibull plot of a static load strength is 20 MPa or more.

(11) The glass for a vehicle according to item (10), in which a terminal joined via the lead-free solder layer has a peel strength of 100 N or more after a moisture resistance test performed under conditions of 80° C. and a humidity of 96% RH for 500 hours.

(12) The glass for a vehicle according to any one of items (1) to (11), in which the lead-free solder layer includes 95 mass % or more of Sn.

(13) The glass for a vehicle according to any one of items (1) to (12), in which the lead-free solder layer is formed via a halogen-free flux.

(14) The glass for a vehicle according to any one of items (1) to (13), in which the ceramic color layer includes, in terms of mass % based on oxides,
15% to 30% of SiO₂,
30% to 55% of Bi₂O₃,
0% to 4% of B₂O₃,
1% to 4% of Al₂O₃,
0% to 3% of Li₂O,
0% to 1.8% of Na₂O+K₂O,
1% to 10% of MgO+CaO+BaO+SrO,
0% to 10% of ZnO,
0% to 5% of TiO₂,
0% to 1% of CeO₂,
0% to 2% of ZrO₂, and
10% to 20% of CuO+CrO+MnO+NiO+CoO, and
contents of components in the ceramic color layer satisfy the following relationships of:

0.15≤Na₂O+K₂O+B₂O₃≤4.0%,

0≤B₂O₃/Bi₂O₃≤0.08, and

0.3≤SiO₂/Bi₂O₃≤1.0.

(15) The glass for a vehicle according to any one of items (1) to (14), being used for a laminated glass for a windshield.

According to the present invention, it is possible to achieve a glass for a vehicle having an excellent solder wettability while including a ceramic color layer and a conductive layer. Therefore, a terminal can be bonded with a high strength via a lead-free solder layer without requiring a thin coating film made of a low-melting-point solder containing lead. Accordingly, even in the case where the lead-free solder is used, floating of a glass phase (amorphous phase) in a glass frit from the ceramic color layer to a surface of the conductive layer can be prevented, and cracking of the glass due to stress concentration and peeling of the ceramic color layer can be prevented.

### BRIEF DESCRIPTION OF DRAWINGS

FIG. 1 is a schematic cross-sectional view illustrating an example of a glass for a vehicle according to the present embodiment.

FIG. 2 is a schematic cross-sectional view illustrating an example of a glass for a vehicle according to the present embodiment.

FIG. 3 is a graph showing a Bi/Ag mass ratio in a firing temperature range of 590° C. to 650° C. in the outermost surface of a conductive layer of the glass for a vehicle according to each of Examples 6, 8, and 9.

FIG. 4 is a scanning microscopic (SEM) image of a cross section of a conductive layer and a ceramic color layer of the glass for a vehicle according to Example 5.

FIG. 5 is an SEM image of a cross section of a conductive layer and a ceramic color layer of the glass for a vehicle according to Example 8.

### DESCRIPTION OF EMBODIMENTS

Hereinafter, the present invention will be described in detail, but the present invention is not limited to the following embodiments, and can be freely modified and implemented without departing from the gist of the present invention. In addition, the symbol “-” or the word “to” that is used to express a numerical range includes the numerical values before and after the symbol or the word as the upper limit and the lower limit of the range, respectively.

<Glass for Vehicle>

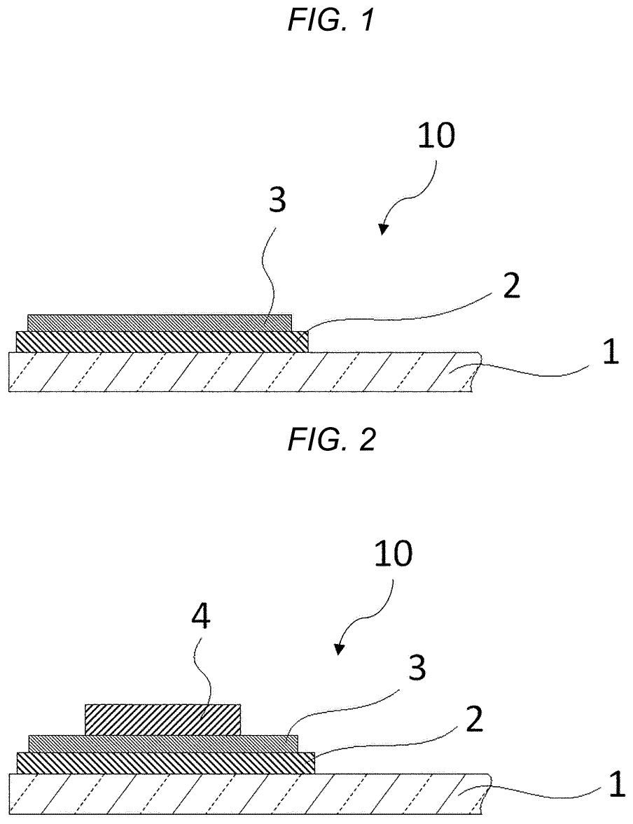

In a glass 10 for a vehicle according to the present embodiment, as illustrated in FIG. 1, a ceramic color layer 2 is formed on a surface of a glass plate 1, and a conductive layer 3 containing silver is further formed on a surface of the ceramic color layer 2. In addition, as illustrated in FIG. 2, it is preferable that a lead-free solder layer 4 be formed on at least a partial region of a surface of the conductive layer 3 containing silver.

The ceramic color layer 2 is a sintered layer containing a glass frit and a pigment, and the glass frit contains bismuth (Bi).

The ceramic color layer may be formed on at least a partial region of the surface of the glass plate. A paste-like ceramic color composition serving as a precursor of the ceramic color layer is applied to a desired region of the surface of the glass plate and then baked to form a sintered layer. In the present specification, the ceramic color layer is a sintered body of a ceramic color composition, and the ceramic color composition is an inorganic component containing a glass frit and a pigment. When the ceramic color composition is applied to the surface of the glass plate, a mixture with an organic component for forming a paste is referred to as a paste-like ceramic color composition.

By using the ceramic color layer as a sintered layer, the ceramic color layer is joined to the glass plate. As a result, even in the case where a conductive layer containing silver (hereinafter, simply referred to as a “conductive layer”), a solder layer, or the like is further formed on the surface of the ceramic color layer, peeling of the ceramic color layer from the glass plate is prevented.

In addition, at the time of firing the ceramic color layer, a curved surface may be formed on the glass plate by bending using heating, which is referred to firing bending.

The conductive layer containing silver may be formed on at least a partial region of the surface of the ceramic color layer. A film of a conductive paste containing silver is formed on a desired region of the surface of the ceramic color layer by coating or the like, and is dried by heating. In addition, a film of a conductive paste containing silver may be formed on a film of the ceramic color composition, and a conductive layer may be formed together with firing for forming a ceramic color layer. In addition, at the time of forming a conductive layer, a curved surface may be formed on the glass plate by the firing bending.

The glass plate of the glass for a vehicle according to the present embodiment often has a curved surface due to its application, and the above-described firing bending may be performed at the time of forming the ceramic color layer and the conductive layer. In addition, the firing bending may be performed after forming the ceramic color layer and the conductive layer. In addition, after the ceramic color layer and the conductive layer are formed, calcination may be performed once, and then the firing bending may be performed.

In the case where a temperature at the time of heating, such as the time of the formation, the time of the calcination, or the time of the firing bending, of the ceramic color layer or the conductive layer is equal to or higher than a softening point of the glass frit, a glass phase in the glass frit is likely to float on the surface of the conductive layer due to the migration, that is, diffusion, of the glass frit constituting the ceramic color layer and is likely to retain on the surface. The floating of the glass phase in the glass frit lowers the solder wettability of the surface of the conductive layer.

Generally, a migration amount increases as a heating temperature increases. The heating temperature may vary depending on the desired radius of curvature of the glass plate, or may have a temperature distribution in one glass plate. Therefore, it is necessary to control the amount of the migration of the glass frit to the conductive layer in a desired wide temperature range.

In the case where a leaded solder is used, a leaded solder having a low melting point is thinly applied to the surface of the conductive layer in advance with an iron or the like, and then the leaded solder is bonded, and thus is less likely to be effected by the migration.

On the other hand, in the case where a lead-free solder is used, a lead-free solder having a low melting point cannot be applied to the surface of the conductive layer, and thus is easily affected by the migration. In addition, in the case where the ceramic color layer used in the leaded solder is applied to the lead-free solder as it is, the glass phase in the glass frit floats on the surface of the conductive layer due to the migration in a temperature range of 550° C. to 600° C. or higher, and the solder wettability decreases, and thus application of the lead-free solder is difficult.

Therefore, in the glass for a vehicle on or above which the ceramic color layer and the conductive layer are formed according to the present embodiment, in order to obtain a good solder wettability, a Bi/Ag mass ratio in the outermost surface of the conductive layer is less than 0.10, more preferably less than 0.09, still more preferably 0.05 or less, and yet still more preferably 0.04 or less. The Bi/Ag mass ratio is obtained by quantifying a detection element containing Bi by mass % from the outermost surface side of the conductive layer by energy dispersive X-ray spectroscopy (SEM-EDX), X-ray photoelectron spectroscopy (XPS), or the like, and normalizing it by Ag.

A firing temperature in a production step of the glass for a vehicle is generally 500° C. to 700° C., and in order to obtain a desired color in this temperature range, it is necessary to cause the glass frit to flow from a low temperature range. For this purpose, it is general to increase the Bi content, but as the firing temperature is higher, the glass phase (amorphous phase) in the glass frit is likely to migrate to the conductive layer, and the Bi/Ag mass ratio in the outermost surface of the conductive layer tends to increase. However, it is newly found that crystallization of the glass frit in the ceramic color layer can reduce the glass phase itself in the glass frit and prevent the migration of the glass phase to the conductive layer, thereby reducing the Bi/Ag mass ratio in the outermost surface of the conductive layer. In addition, it is also newly found that crystallization of the glass phase migrated into the conductive layer can prevent the migration of the glass phase to the outermost surface of the conductive layer. That is, by increasing a crystallized region derived from the glass frit in the ceramic color layer, and by including the crystallized region derived from the glass frit in the conductive layer, the migration of the glass frit to the outermost surface of the conductive layer can be favorably prevented. As a result, the Bi/Ag mass ratio in the outermost surface of the conductive layer can be made lower than that in the related art, and a good solder wettability to the lead-free solder can be achieved. It is further newly found that control of a SiO₂/Bi₂O₃ ratio in the ceramic color layer is also important in setting the crystallized region in the ceramic color layer or the conductive layer as described above.

Since the temperature of firing or firing bending of the ceramic color layer is generally about 500° C. to 700° C., in the case where a Bi/Ag mass ratio of a glass for a vehicle subjected to a firing step at a temperature of at least 500° C. or higher is less than 0.10, a solder wettability is considered to be good, and the Bi/Ag mass ratio is preferably less than 0.09, more preferably 0.05 or less, and still more preferably 0.04 or less. In addition, a Bi/Ag mass ratio of a glass for a vehicle subjected to a firing step at a temperature of 590° C. or higher is preferably less than 0.10, more preferably less than 0.09, still more preferably 0.05 or less, and yet still more preferably 0.04 or less. In addition, a Bi/Ag mass ratio of a glass for a vehicle subjected to a firing step at a temperature of 630° C. or higher is preferably less than more preferably less than 0.09, still more preferably 0.05 or less, and yet still more preferably 0.04 or less.

Further, an average value of Bi/Ag mass ratios of a glass for a vehicle subjected to a firing step in a whole temperature range of 590° C. to 650° C. is preferably less than 0.10, more preferably less than 0.09, still more preferably 0.05 or less, and yet still more preferably 0.04 or less. In addition, the maximum value of the Bi/Ag mass ratios of the glass for a vehicle subjected to the firing step in the whole temperature range of 590° C. to 650° C. is preferably less than 0.10, more preferably less than 0.09, still more preferably 0.05 or less, and yet still more preferably 0.04 or less.

A concentration of the glass frit due to the migration to the conductive layer, typically a concentration of Bi, has a gradient. Specifically, in the conductive layer, the amount of Bi increases toward the ceramic color layer. In addition, in the conductive layer, the amount of Bi gradually decreases toward the surface. However, Bi migrated to the outermost surface loses the destination and retains. Therefore, the Bi/Ag mass ratio at a certain depth from the outermost surface of the conductive layer may be smaller than the Bi/Ag mass ratio in the outermost surface of the conductive layer.

Therefore, in the case where the layer where Bi retains is referred to as an outermost layer, the thickness of the outermost layer in a depth direction from the outermost surface of the conductive layer is preferably 0 μm to 2 μm, more preferably 0 μm to 1.5 μm, still more preferably 0 μm to 1 μm, and yet still more preferably 0 μm to 0.5 μm. The thinner the outermost layer is, the smaller the amount of Bi retained is, and it can be determined that the smaller the amount of the migration to the conductive layer is.

The migration can be quantified by using a value represented by a product of a mass concentration of O (oxygen) in the outermost surface of the conductive layer containing silver and a thickness of the conductive layer containing silver {(mass concentration of O)×(thickness of conductive layer containing silver)} as a migration amount.

From the viewpoint of obtaining a good solder wettability, the migration amount represented by the product is preferably 75%·μm or less, more preferably 70%μm or less, and still more preferably 60% μm or less. In addition, from the viewpoint of increasing a bonding force of an interface between the ceramic color layer and the conductive layer, the migration amount is preferably 25% μm or more, more preferably 40% μm or more, and still more preferably 50% μm or more. In the case where Bi retains on the outermost surface of the conductive layer as described above, the migration amount represented by the product is excessively calculated as compared with the case where Bi does not retain, and is larger than an actual migration amount. However, since the fact that Bi retains on the outermost surface means that the migration amount is large in the first place, the migration amount represented by the product is preferably 75%. μm or less regardless of whether Bi retains.

The migration amount is a value when the glass for a vehicle is heated at 630° C. However, the migration amount of the glass for a vehicle varies depending on the heating temperature, but the difference is not so large. Therefore, for example, in the case where the migration amount at the time of heating at 630±30° C. is within ±2% of the above range, it can be presumed that the migration amount at the time of heating at 630° C. is also within the above range.

The mass concentration (mass %) of oxygen in the outermost surface of the conductive layer is obtained by energy dispersive X-ray spectroscopy (SEM-EDX) or the like from the outermost surface side of the conductive layer. In addition, the thickness of the conductive layer may be a value measured by a cross-sectional SEM. In addition, a value obtained by performing a step measurement using a contour shape integration measuring machine in a portion where the conductive layer is formed and a portion where the conductive layer is not formed, that is, a region of only a portion where the ceramic color layer is formed in a region where the conductive layer is formed may be adopted.

The Bi/Ag mass ratio in the outermost surface of the conductive layer can be controlled by the composition, crystallinity, firing conditions, and the like of the ceramic color composition as the precursor of the ceramic color layer. By increasing a crystallized region in the ceramic color layer, that is, increasing the crystallinity, the glass phase in the ceramic color layer is reduced, and as a result, the amount itself of the migration of the glass phase in the glass frit into the conductive layer can be reduced.

In addition, by crystallizing the glass phase itself migrated into the conductive layer to form a crystallized region, the glass phase which is a component containing Bi in the glass frit can also be prevented from floating up to the outermost surface of the conductive layer. The crystallized region in the ceramic color layer or the conductive layer can be controlled by, for example, the SiO₂/Bi₂O₃ ratio of the ceramic color layer.

As a result, the Bi/Ag mass ratio in the outermost surface of the conductive layer can be reduced.

For the above reasons, the ceramic color layer preferably includes a large amount of a crystallized region derived from the glass frit, and the conductive layer preferably includes a crystallized region derived from the glass frit.

The crystallized region derived from the glass frit in the ceramic color layer is a region in which the glass frit in the ceramic color composition becomes a crystal phase. In addition, the crystallized region derived from the glass frit in the conductive layer is a region in which the glass phase in the glass frit migrated into the conductive layer from the ceramic color layer or the ceramic color composition as a precursor of the ceramic color layer becomes a crystal phase. Due to the presence of the crystallized region, the glass phase may not be present in the outermost surface of the conductive layer, or even in the case where the glass phase is present, the amount thereof can be greatly reduced, and the Bi/Ag mass ratio in the outermost surface of the conductive layer can be reduced.

The glass frit is crystallized by being subjected to a heat treatment at a temperature higher than a crystallization temperature at the time of firing when forming the ceramic color layer or the conductive layer or at the time of firing bending the glass. That is, the glass phase in the glass frit migrated into the conductive layer can also be crystallized by the heat treatment according to the composition.

From the above viewpoint, it is preferable to add a crystallization promoter to the ceramic color composition. By the presence of the crystallization promoter, a crystal phase derived from the glass frit is easily formed. That is, in the case where the crystallization promoter serves as a nucleus, crystallization starts in a temperature range lower than a temperature at which the glass frit generally starts to be crystallized, and the glass phase of the glass frit is also easily crystallized. Further, more uniform crystallization is facilitated in the ceramic color layer. By these effects, an absolute amount of the glass phase that migrates into the conductive layer is reduced. As a result, the migration of the glass phase in the glass frit to the outermost surface of the conductive layer can be prevented.

Although the crystallization promoter varies depending on the composition of the glass frit, a bismuth silicate-based crystallization promoter is preferable because the glass frit contains Bi, and examples thereof include Bi₄Si₃O₁₂ and Bi₁₂SiO₂₀. In addition, in the case where the crystal phase has a similar pattern, crystallization may be promoted even in the case where the composition is different.

For example, in the case where the content of each component based on oxides of the ceramic color layer satisfies the relationship of SiO₂/Bi₂O₃≥0.3, a low-expansion Bi₄Si₃O₁₂ crystal is precipitated, and expansion of the ceramic color layer can be reduced. Therefore, it is preferable to add Bi₄Si₃O₁₂ as the crystallization promoter which is the same as the crystal to be precipitated. However, since transfer to the Bi₄Si₃O₁₂ crystal occurs in the case where the temperature becomes 500° C. or higher in the ceramic color layer also in Bi₁₂SiO₂₀ which has a different crystal system, Bi₁₂SiO₂₀ may also be used as a crystallization promoter. However, in the case where the same crystal system as the crystal system to be precipitated is used as the crystallization promoter, the effect is large even in the case where the crystallization promoter is added in a small amount, and thus the crystallization promoter is preferably Bi₄Si₃O₁₂.

The glass phase in the glass frit migrated into the ceramic color layer or the conductive layer is preferably present as a crystallized region, and more preferably has a large precipitation amount, that is, a high crystallinity. As an indicator of the presence of the crystallized region, a rod-like crystal, a needle-like crystal, a granular crystal, or the like can be confirmed in a cross-sectional SEM photograph. In addition, at the time of measuring by an X-ray diffraction method (XRD) or an oblique incidence X-ray diffraction measurement, a diffraction peak of a bismuth silicate crystal derived from the glass frit is preferably detected. In this case, since Bi₄Si₃O₁₂ or the like is added as the crystallization promoter, the diffraction peak of the bismuth silicate crystal may be detected at a minute intensity. However, in the case where the components in the glass frit are crystallized, the strength is much higher than the strength of the added crystallization promoter only, and thus it is sufficiently possible to distinguish an additive as the crystallization promoter from a product by the precipitation. Specifically, crystallinity to the extent that the strength is several tens of times or more than the strength of the crystallization promoter only is preferable, and crystallinity to the extent that the strength is several hundreds of times or more than the strength of the crystallization promoter only is more preferable.

In XRD or oblique incidence X-ray diffraction measurement, a diffraction line due to a crystal phase has a peak, and scattered light due to an amorphous phase is detected as a halo. The crystallinity can be calculated using the following equation by fitting the halo and the crystallinity peak and analyzing each intensity.

Crystallinity X=I_{c}/(I_{c}+Iₐ)×100

(I_{c}: crystalline scattering integrated intensity, Iₐ: amorphous scattering integrated intensity)

The crystallinity X derived from the glass frit in each of the ceramic color layer and the conductive layer in the present embodiment is preferably 10% or more, more preferably 20% or more, still more preferably 30% or more, and yet still more preferably 40% or more. On the other hand, in the case where the crystallinity is excessively high, the amount of the amorphous glass component becomes excessively small, and it may be difficult to satisfy the characteristics such as the color tone required for the glass for a vehicle. Therefore, the crystallinity X is preferably 70% or less, more preferably 60% or less, and still more preferably 50% or less. The crystallinity in the ceramic color layer and the crystallinity in the conductive layer may be the same or different.

The softening point Ts of the glass frit is also related to the temperature when the glass is subjected to the firing bending. From the viewpoint of good baking, the softening point Ts of the glass frit is preferably 500° C. or higher, and more preferably 520° C. or higher. On the other hand, as the firing bending temperature is higher, the migration of the glass frit to the conductive layer becomes more active. From the viewpoint of reducing the migration amount, the softening point Ts of the glass frit is preferably 580° C. or lower, and more preferably 540° C. or lower.

The softening point Ts of the glass frit can be controlled by the composition of the glass frit. The softening point Ts in the present specification is a temperature corresponding to a fourth inflection point in a DTA chart obtained by differential thermal analysis (DTA) of the glass frit. Although it is difficult to directly measure the softening point Ts of the glass frit from the glass for a vehicle after firing, the composition of the glass frit can be estimated from the composition of the ceramic color layer or the like, and the softening point Ts can be estimated from regression calculation using the composition of the glass frit.

A particle diameter D₅₀ of the glass frit is also related to the temperature when the glass is subjected to the firing bending. The smaller the particle diameter D₅₀ of the glass frit is, the more the glass flows at a low temperature to easily obtain a desired color tone, but the amount of the migration to the conductive layer also tends to increase. On the other hand, in the case where the particle diameter of the glass frit is large, the flow of the glass shifts to a high temperature side, and a desired color tone is difficult to be obtained, but a large particle diameter contributes to prevention of the amount of the migration to the conductive layer.

In addition, even in the case where the particle diameter D₅₀ of the glass frit is small, it is possible to adjust the amount of the migration to the conductive layer while maintaining a desired color tone by increasing the crystallinity. Further, by setting the particle size distribution having two local maximum values in a particle size distribution curve, that is, a bimodal curve, the amount of the migration to the conductive layer can be adjusted while maintaining a desired color tone. The particle size distribution curve may be a particle size distribution having three or more maximum values, that is, a trimodal or more curve.

Specifically, in the case where the particle diameter D₅₀ of the glass frit has a bimodal curve in a volume-based particle size distribution curve measured by a laser diffraction scattering method, the first peak of the bimodal value is preferably between 0.1 μm and 1.0 μm, more preferably between 0.3 μm and 1.0 μm, still more preferably between 0.3 μm and 0.9 μm, yet still more preferably between 0.3 μm and 0.8 μm, and particularly preferably between 0.5 μm and 0.8 μm. The second peak of the bimodal value is preferably between 1.0 μm and 3.0 μm, more preferably between 1.0 μm and 2.5 μm and still more preferably between 1.0 μm and 2.0 μm.

As the pigment in the ceramic color layer, a known pigment can be used. For example, a combination of CuO·Cr₂O₃ (black), CoO·Cr₂O₃ (black), Fe₂O₃ (brown), TiO₂ (white), CoO·Al₂O₃ (blue), NiO·Cr₂O₃ (green) and the like can be used. In the case where such a pigment is used, a desired color, gloss, and opacity, that is, characteristics of transmittance can be imparted. Among them, from the viewpoint of providing the ceramic color layer, it is preferable that the ceramic color layer be a black ceramic layer including a black pigment.

The pigment in the case of the black ceramic layer is preferably at least one oxide pigment selected from the group consisting of Cu, Fe, Co, Ni, Cr, Si, Mn, Al, and Zn, more preferably a composite oxide pigment containing two or more of these pigments, and still more preferably at least one composite oxide pigment selected from the group consisting of Cu(Cr,Mn)₂O₄, CuCrO₄, Cr₂O₃:Fe₂O₃, Cr₂O₃:Fe₂O₃:CoO, (Fe,Mn)(Mn,Fe)₂O₄, (Co,Fe)(Fe,Cr)₂O₄, (Co,Fe,Mn)(Fe,Cr,Mn)₂O₄, (Co,Fe)(Ni,Cr)₂O₄, and (Cu,Fe,Mn)(Fe,Mn,Al)₂O₄.

In the case where the ceramic color layer is a black ceramic layer, the color can be represented by a brightness index L* value in a CIE 1976 (L*a*b*) color space (CIELAB) standardized by the International Commission on Illumination (CIE). The brightness index L* value is an index indicating a brightness of a color tone, and can be measured in accordance with JIS Z 8722 (2009). In the case where the L* value is large, a color tone is bright, and in the case where the brightness index L* value is small, a color tone is dark. In the case where the L* value of the black ceramic layer is in the range of 0 to 30, the black ceramic layer becomes black, and the object as the glass for a vehicle is achieved. Further, from the viewpoint of enhancing an aesthetic satisfaction with a high quality feeling, the L* value is preferably 18 or more, more preferably 20 or more, and still more preferably 21 or more in consideration of a black color degree of the L* value. On the other hand, in the case where the L* value exceeds 30, a white color degree increases. Therefore, the L* value is preferably 30 or less, more preferably 25 or less, and still more preferably 23 or less.

The ceramic color layer preferably further contains a filler in addition to the glass frit and the pigment. The above-described crystallization promoter is included in the filler.

The filler other than the crystallization promoter is preferably a filler called a low-expansion filler from the viewpoint of improving the strength of the glass for a vehicle. The reason is that a glass frit or a pigment generally has a higher thermal expansion coefficient than a glass plate.

When a solder layer is provided on the glass for a vehicle, a stress due to a difference in thermal expansion coefficient between the glass plate and the solder may be generated in addition to a thermal stress due to a local heating of the glass plate at the time of soldering and a residual stress after cooling, thereby reducing the strength of the glass for a vehicle. On the other hand, by containing the low-expansion filler in the ceramic color layer interposed between the glass plate and the solder layer, expansion of the ceramic color layer due to a local heating of the glass plate during soldering can be reduced. Accordingly, the stress caused by the difference in the thermal expansion coefficient between the glass plate and the solder can be reduced, and a decrease in the strength of the glass for a vehicle can be prevented.

From the viewpoint of the thickness of the ceramic color layer, the particle diameter D₅₀ of the low-expansion filler is preferably 15 μm or less, more preferably 10 μm or less, and still more preferably 8 μm or less. On the other hand, from the viewpoint of preventing the sinterability from deteriorating due to excessive atomization, the particle diameter D₅₀ is preferably 1 μm or more, more preferably 3 μm or more, and still more preferably 4 μm or more.

The low-expansion filler may be bimodal, trimodal or more indicating a peak at two or more portions, or may be unimodal indicating a peak at one portion in a volume-based particle size distribution curve measured by a laser diffraction scattering method. However, as described above, in the case where the amount of fine particles is large, the sinterability is lowered, and therefore, in the case where emphasis is placed on the sinterability, the unimodal curve containing no fine particles is preferable. In the case of the unimodal curve, it is more preferable that the maximum peak be at 4 μm to 8 μm. In order to obtain a unimodal particle size distribution, pulverization conditions may be optimized or classified.

A shape of the low-expansion filler is preferably a spherical shape or a crushed shape. The spherical shape has a small specific surface area per unit volume, and thus is excellent in fluidity when the ceramic color layer is used as a sintered layer, and has a high sinterability. Therefore, the ceramic color layer can contain a relatively large amount of the low-expansion filler. On the other hand, the crushed shape is slightly inferior to the spherical shape in the sinterability, but the crushed shape is preferable since it can be mass-produced at low cost and is easily available.

Examples of the low-expansion filler include cordierite, zircon, alumina, titania, zirconium phosphate, silica, and forsterite. One of these may be used, or two or more thereof may be used in combination. Among these, it is more preferable to contain at least one selected from the group consisting of cordierite, zircon, and silica. In the case of cordierite, zircon, or silica, it may be in a crushed shape, but is more preferably in a spherical shape, and in the case of silica, a spherical silica is further preferable.

Silica may be crystalline or amorphous. Silicon (Si—OH) to which a hydroxyl group called a silanol group is bonded is bonded is present on the surface of silica, and is responsible for a major cause of physical properties such as water repellent and hydrophilicity. In the case of a amorphous silica, the amount of silicon (Si—OH) to which hydrogen is bonded is larger than that of a crystalline silica. Therefore, the bonding force is increased at the time of adhering with a urethane sealant and the like. Therefore, silica is more preferably amorphous.

The ceramic color layer may further contain an oxidizing agent as long as the effect of the present invention is not impaired.

As the oxidizing agent, a known oxidizing agent can be used, and examples thereof include CeO₂ and MnO₂. The average particle diameter D₅₀ of the oxidizing agent is preferably 0.1 μm or more from the viewpoint of productivity, more preferably 1 μm or more, and still more preferably 3 μm or more from the viewpoint of the sinterability. On the other hand, from the viewpoint of coating properties such as screen printing, the average particle diameter D₅₀ of the oxidizing agent is preferably 15 μm or less, and more preferably 10 μm or less.

A thermal expansion coefficient of the ceramic color layer needs to be equal to or less than the thermal expansion coefficient of the glass plate. On the other hand, the thermal expansion coefficient of the ceramic color layer is preferably close to the thermal expansion coefficient of the glass plate from the viewpoint of obtaining a high strength as the glass for a vehicle. By making the thermal expansion coefficient of the ceramic color layer close to the thermal expansion coefficient of the glass plate, even in the case where a residual stress is generated in the glass plate at the time of providing the solder layer on the glass for a vehicle, expansion of the ceramic color layer and the conductive layer can be prevented, and a decrease in the strength of the glass for a vehicle can be prevented.

Therefore, in view of the fact that a thermal expansion coefficient of a soda-lime glass is 85×10⁻⁷/° C. to 90×10⁻⁷/° C., for example, the thermal expansion coefficient of the ceramic color layer at 50° C. to 350° C. is preferably 40×10⁻⁷° C. or more, more preferably 50×10⁻⁷° C. or more, and still more preferably from 60×10⁻⁷/° C. or more. In addition, the thermal expansion coefficient of the ceramic color layer at 50° C. to 350° C. is preferably 85×10⁻⁷/° C. or less, more preferably 80×10⁻⁷/° C. or less, and still more preferably from 77×10⁻⁷/° C. or less. Since it is difficult to directly measure the thermal expansion coefficient of the ceramic color layer, the thermal expansion coefficient in the present specification is a value measured using a differential thermal dilatometer from an average value of percentages of elongation per 1° C. at the time of heating the ceramic color composition in the range of 50° C. to 350° C.

Regarding the ceramic color layer, strain occurs in the case where there is a difference in thermal expansion coefficient between the ceramic color layer and the glass plate, but the strain of the glass plate can be measured using a polarized light, and the residual stress applied to the glass plate can be calculated from the measurement. Specifically, a magnitude of birefringence is measured, and the residual stress is calculated using a separately obtained photoelastic constant of the glass plate. A device for measuring the birefringence is commercially available from, for example, Luceo Co., Ltd, Orihara Manufacturing Co., Ltd., and HINDS Instruments, and a crossed Nicols method, a circular polarization method, a sensitive tint method, a Senarmont method, a rotating analyzer method, or the like is adopted. Here, it should be noted that the stress that can be measured by these residual stress measuring devices is a stress of a transparent portion of the glass plate, and the stress of the ceramic color layer cannot be measured. The ceramic color layer needs to be considered by estimating that a stress balanced with the stress of the glass plate remains.

As a general glass plate of the glass for a vehicle, a composition of a soda-lime glass plate is, in terms of mass % based on oxides, silica (SiO₂): 70 mass % to 73 mass %, alumina (Al₂O₃): 0.6 mass % to 2.4 mass %, iron oxide (Fe₂O₃): 0.08 mass % to 0.14 mass %, lime (CaO): 7 mass % to 12 mass %, magnesia (MgO): 1.0 mass % to 4.5 mass %, and alkali metal (R₂O: Na₂O+K₂O): 13 mass % to 15 mass %. In such a composition, since an addition amount of R₂O is very large, it is known that Na (sodium ion) or K (potassium ion) is dissolved in water as a glass component of an extremely small amount from a surface where water and the glass plate are in contact with each other. The dissolved Na and K react with carbon dioxide in the air to form salts such as sodium carbonate and potassium carbonate. This is an erosion phenomenon of a glass surface due to a general moisture adhesion, that is, burning of the glass. In addition, the reacted sodium carbonate or potassium carbonate itself has a property of being easily re-dissolved in water.

Also in a moisture resistance test of the ceramic color layer, a reaction between the ceramic color layer and moisture may occur similarly to the glass plate. That is, in the case where the ceramic color layer contains a large amount of a sodium component and a potassium component which are easily soluble in water, a weathering phenomenon of glass may occur on the surface of the ceramic color layer. However, since a lithium salt such as lithium carbonate, which also belongs to an alkali metal group, has a low solubility in water, if the lithium salt is included, the weathering phenomenon of the glass is difficult to occur even in the case where the content of the sodium component or the potassium component is equal.

The peel strength at the interface between the ceramic color layer and the conductive layer correlates with the bonding force at the interface between the ceramic color layer and the conductive layer. Further, in the moisture resistance test, a decrease in the bonding force due to water may occur, and it is necessary to prevent the decrease in the bonding force in order to keep the peel strength high.

From the viewpoint of increasing the bonding force at the interface between the ceramic color layer and the conductive layer, it is advantageous to increase the amount of the migration from the ceramic color layer to the conductive layer. However, in the case where the amount of the migration is increased, the solder wettability deteriorates. On the other hand, in order to improve the solder wettability, it is necessary to prevent the migration from the ceramic color layer to the conductive layer. Therefore, it is preferable to increase the crystallinity of the ceramic color layer. However, in the case where the crystallinity is excessively increased, the migration from the ceramic color layer to the conductive layer is prevented, but as described above, the bonding (adhesion) force between the ceramic color layer and the conductive layer is weakened. In this way, since both are in a tread-off relation, it is important to appropriately cause the migration from the ceramic color layer to the conductive layer.

In addition, the peel strength after the moisture resistance test also contributes to the amount of a hydrophilic component at the interface between the ceramic color layer and the conductive layer. That is, moisture penetrates through the interface between the ceramic color layer and the conductive layer due to moisture in the moisture resistance test, and the hydrophilic component dissolves, whereby voids are generated between the ceramic color layer and the conductive layer, and a tensile strength decreases at the peeling test. Therefore, it is important to control the composition of the interface between the ceramic color layer and the conductive layer, particularly the hydrophilic component.

It is difficult to directly measure the amount of the hydrophilic component at the interface between the ceramic color layer and the conductive layer. However, in a region of about hundreds of micro meters of the ceramic color layer in which the conductive layer is not formed from an end of the conductive layer, the migration spreads to both sides, and therefore, the composition can be regarded as equivalent to the composition of the outermost surface of the ceramic color layer on which the conductive layer is not formed. Therefore, the quality of a concentration of the hydrophilic component at the interface between the ceramic color layer and the conductive layer can be determined by analyzing the composition of the outermost surface of the ceramic color layer in a region within hundreds of micro meters from the end of the conductive layer.

The composition of the ceramic color composition before firing, the composition of the ceramic color layer after firing, and the composition of the outermost surface of the ceramic color layer after the moisture resistance test may be the same, but phase separation between the crystal phase and the glass phase caused by the crystallization may occur, or the alkali metal or the like may move and dissolve in the ceramic color layer, and therefore, the composition of the outermost surface may change.

Na₂O and K₂O are hydrophilic components, and in addition, B₂O₃ is also a hydrophilic component. From the viewpoint of obtaining a good peel strength after the moisture resistance test, it is preferable to reduce the total content represented by (Na₂O+K₂O+B₂O₃) in the ceramic color composition to be low. On the other hand, since it is difficult to quantify boron (B) by surface analysis, the amount of B₂O₃/Bi₂O₃ in the ceramic color composition, that is, the total composition including the filler and the pigment in addition to the glass frit is controlled regarding B. Specifically, the value of B₂O₃/Bi₂O₃ in the composition of the ceramic color composition is preferably 0.08 or less.

On the other hand, the content of Na₂O, K₂O, and Bi₂O₃ in the outermost surface of the ceramic color layer is obtained by SEM-EDX analysis or XPS of the surface portion of the ceramic color layer. Therefore, it is determined by Na₂O, K₂O, and Bi₂O₃ analysis values. Specifically, on the outermost surface of the ceramic color layer after the moisture resistance test, the value of {(Na₂O+K₂O)/Bi₂O₃} represented by the contents of Na 2 O, K₂O, and Bi₂O₃ is preferably less than 0.20, more preferably 0.10 or less, and a smaller value is more preferable. The moisture resistance test is a test under the conditions of 80° C. and a humidity of 96% RH for 500 hours.

In the SEM-EDX, it is possible to analyze only a layer closer to the surface of the ceramic color layer by decreasing an acceleration voltage. In consideration of the thickness of the ceramic color layer, the standard of the acceleration voltage excited with a sufficient intensity is preferably 5 kV to 15 kV, and more preferably 5 kV to 10 kV. In addition, the thickness of the ceramic color layer at this time is preferably less than 15 μm.

The ceramic color layer preferably satisfies, for example, the following composition. The composition of the ceramic color layer in the present specification is a total composition of the glass frit and the pigment, and in the case where the ceramic color layer further contains another inorganic component such as the filler, the composition of the ceramic color layer in the present specification also contains the inorganic component. In addition, the composition of the ceramic color layer may be regarded as the same as the composition of the ceramic color composition before firing.

In terms of mass % based on oxides,
15% to 30% of SiO₂,
30% to 55% of Bi₂O₃,
0% to 4% of B₂O₃,
1% to 4% of Al₂O₃,
0% to 3% of Li₂O,
0% to 1.8% of Na₂O+K₂O,
1% to 10% of MgO+CaO+BaO+SrO,
0% to 10% of ZnO,
0% to 5% of TiO₂,
0% to 1% of CeO₂,
0% to 2% of ZrO₂, and
10% to 20% of CuO+CrO+MnO+NiO+CoO are contained, and
contents of components in the ceramic color layer satisfy the following relationships of:

0.1%≤Na₂O+K₂O+B₂O₃≤4.0%,

0≤B₂O₃/Bi₂O₃≤0.08, and

0.3≤SiO₂/Bi₂O₃≤1.0.

The ceramic color layer more preferably satisfies, for example, the following composition.

In terms of mass % based on oxides,
15% to 30% of SiO₂,
30% to 55% of Bi₂O₃,
0% to 4% of B₂O₃,
1% to 4% of Al₂O₃,
0% to 3% of Li₂O,
0% to 1.8% of Na₂O+K₂O,
1% to 10% of MgO+CaO+BaO+SrO,
0% to 10% of ZnO,
0% to 5% of TiO₂,
0% to 1% of CeO₂,
0% to 2% of ZrO₂, and
10% to 20% of CuO+CrO+MnO+NiO+CoO are contained, and
contents of components in the ceramic color layer satisfy the following relationships of:

0.1%≤Na₂O+K₂O+B₂O₃≤3.0%,

0≤B₂O₃/Bi₂O₃≤0.08, and

0.3≤SiO₂/Bi₂O₃≤1.0.

The ceramic color layer still more preferably satisfies, for example, the following composition.
25 In terms of mass % based on oxides,
15% to 28.6% of SiO₂,
40% to 55% of Bi₂O₃,
0% to 4% of B₂O₃,
1% to 4% of Al₂O₃,
0% to 3% of Li₂O,
0% to 1.8% of Na₂O+K₂O,
1% to 10% of MgO+CaO+BaO+SrO,
0% to 10% of ZnO,
0% to 5% of TiO₂,
0% to 1% of CeO₂,
0% to 2% of ZrO₂, and
10% to 20% of CuO+CrO+MnO+NiO+CoO are contained, and
contents of components in the ceramic color layer satisfy the following relationships of:

0.1%≤Na₂O+K₂O+B₂O₃≤3.0%,

0≤B₂O₃/Bi₂O₃≤0.08, and

0.3≤SiO₂/Bi₂O₃≤0.65.

The ceramic color layer yet still more preferably satisfies, for example, the following composition.

In terms of mass % based on oxides,
20% to 28.6% of SiO₂,
49% to 55% of Bi₂O₃,
0% to 3% of B₂O₃,
1% to 4% of Al₂O₃,
0% to 3% of Li₂O,
0% to 1.4% of Na₂O+K₂O,
1% to 10% of MgO+CaO+BaO+SrO,
0% to 6% of ZnO,
0.1% to 1.5% of TiO₂,
0% to 1% of CeO₂,
0% to 0.5% of ZrO₂, and
10% to 15% of CuO+CrO+MnO+NiO+CoO are contained, and
contents of components in the ceramic color layer satisfy the following relationships of:

0.1%≤Na₂O+K₂O+B₂O₃≤3.0%,

0≤B₂O₃/Bi₂O₃≤0.07, and

0.35≤SiO₂/Bi₂O₃≤0.65.

The ceramic color layer particularly preferably satisfies, for example, the following composition.

In terms of mass % based on oxides,
20% to 25% of SiO₂,
49% to 55% of Bi₂O₃,
0% to 2% of B₂O₃,
2% to 4% of Al₂O₃,
0% to 1.5% of Li₂O,
0% to 1% of Na₂O+K₂O,
4% to 10% of MgO+CaO+BaO+SrO,
0% to 1% of ZnO,
0.1% to 1% of TiO₂,
0% to 1% of CeO₂,
0% to 0.5% of ZrO₂, and
10% to 15% of CuO+CrO+MnO+NiO+CoO are contained, and
contents of components in the ceramic color layer satisfy the following relationships of:

0.1%≤Na₂O+K₂O+B₂O₃≤3.0%,

0≤B₂O₃/Bi₂O₃≤0.07, and

0.35≤SiO₂/Bi₂O₃≤0.65.

SiO₂ in the glass frit forms a glass network and is also a crystalline component. In addition, in order to control chemical, thermal, and mechanical properties, a content of SiO₂ in the glass frit is preferably large. On the other hand, from the viewpoint of preventing the softening point Ts of the glass frit from becoming excessively high and preventing the fluidity of the glass from being lowered, the content of SiO₂ in the glass frit is preferably small.

In addition, the SiO₂ component in the filler is a component necessary for maintaining the strength of the ceramic color layer as a cover layer covering the glass plate, controlling the crystallinity, and the like. SiO₂ may be contained as a composite such as Bi₄Si₃O₁₂, instead of SiO₂ alone. On the other hand, in the case where the content of the SiO₂ component in the filler is extremely large, the sinterability of the ceramic color layer decreases.

From these viewpoints, the content of SiO₂ in the ceramic color layer which is a total of inorganic components including the glass frit, the pigment, the filler, and the like, is preferably 15 mass % or more, and more preferably 20 mass % or more. In addition, the content of SiO₂ is preferably 30 mass % or less, more preferably 28.6 mass % or less, and still more preferably 25 mass % or less.

Bi₂O₃ in the glass frit is a component forming a glass network, and is also effective as a low softening component. In addition, by allowing SiO₂ to coexist in the glass frit, a bismuth silicate crystal is easily precipitated. From the viewpoint of the fluidity of the glass, a content of Bi₂O₃ in the glass frit is preferably large. On the other hand, in the case where the content of Bi₂O₃ in the glass frit is extremely large, a chemical durability decreases.

In addition, by adding a component containing Bi₂O₃ to the filler, the crystallinity can be easily controlled. Bi₂O₃ may be contained as a composite such as Bi₄Si₃₀₁₂, instead of Bi₂O₃ alone.

From these viewpoints, the content of Bi₂O₃ in the ceramic color layer is preferably mass % or more, more preferably 40 mass % or more, and still more preferably 49 mass % or more. In addition, the content of Bi₂O₃ is preferably 55 mass % or less.

B₂O₃ in the glass frit is not essential, but in the case of being contained, B₂O₃ acts as a flux and can improve the meltability of the glass. On the other hand, in the case where a content of B₂O₃ in the glass frit is extremely large, releasability, an acid resistance, and a moisture resistance decrease.

In addition, although the strength retention of the coating layer is more excellent as the amount of the B₂O₃ component in the filler increases, crystallization is reduced by the reaction between the Bi₂O₃ component in the glass frit and the B₂O₃ component in the filler, and as a result, the glass phase may increase and the releasability may decrease.

From these viewpoints, the content of B₂O₃ in the ceramic color layer is preferably 4 mass % or less, more preferably 3 mass % or less, and still more preferably 2 mass % or less.

An Al₂O₃ component in the glass frit or the filler is not essential, but in order to maintain the strength of the coating layer, a content of Al₂O₃ in the ceramic color layer is preferably 1 mass % or more, and more preferably 2 mass % or more. On the other hand, from the viewpoint of preventing a decrease in the sinterability, the content of Al₂O₃ is preferably 4 mass % or less. Al₂O₃ may be contained as a composite such as cordierite, instead of Al₂O₃ alone.

Li₂O in the glass frit is not essential, but in the case of being contained, Li₂O can remarkably improve the meltability of the glass as a flux component. In addition, since Li has a lower solubility in water than Na and K which generate carbonates and the like by reaction with water, the carbonates and the like are less likely to be generated by Li, and the advantage as a flux is produced. On the other hand, the amount of Li₂O in the glass frit is preferably small from the viewpoint of preventing a thermal expansion coefficient from becoming extremely large.

From these viewpoints, Li₂O in the ceramic color layer may be contained in a larger amount than Na₂O and K₂O, and a content thereof is preferably 3 mass % or less, and more preferably 1.5 mass % or less. On the other hand, the content of Li₂O is preferably 0.1 mass % or more, and more preferably 0.5 mass % or more.

Na 2 O and K₂O in the glass frit are not essential, but in the case of being contained, Na₂O and K₂O can improve the meltability of the glass similarly to Li₂O in the glass frit. On the other hand, Na₂O and K₂O in the glass frit have a better property of increasing a thermal expansion coefficient than Li₂O in the glass frit. Further, Na₂O and K₂O in the glass frit are hydrophilic components, and thus affect the moisture resistance. Therefore, it is necessary to reduce a total content of Na 2 O and K₂O in the glass frit, and as a result, it is also necessary to reduce a total content of Na₂O and K₂O in the ceramic color layer.

From these viewpoints, the total content of Na₂O and K₂O in the ceramic color layer is preferably 1.8 mass % or less, more preferably 1.4 mass % or less, still more preferably 1.0 mass % or less, and yet still more preferably 0.5 mass % or less.

Alkali-earth metal oxides in the glass frit are all optional components. The components facilitate vitrification. However, in the case where a content thereof is extremely large, the stability of the glass decreases and the glass is likely to devitrify.

In addition, an MgO component contained in cordierite that is the filler maintains the strength of the coating layer.

However, in the case where a content of the alkali-earth metal oxides in the ceramic color layer increases, the sinterability decreases. From these viewpoints, a total content of the alkali-earth metal oxides in the ceramic color layer is preferably 1 mass % or more, and more preferably 4 mass % or more. On the other hand, the total content of the alkali-earth metal oxides in the ceramic color layer is preferably 10 mass % or less. The total content of the alkali-earth metal oxides in the present specification is a content represented by (MgO+CaO+BaO+SrO). For example, an alkali metal oxide may be contained as a composite such as cordierite, instead of the alkali metal oxide alone.

ZnO in the glass frit is not essential, but in the case of being contained, the thermal expansion coefficient can be reduced. On the other hand, in the case where a content of ZnO in the glass frit is extremely large, the stability of the glass decreases, and the glass is likely to devitrify.

From these viewpoints, the content of ZnO in the ceramic color layer is preferably mass % or less, more preferably 6 mass % or less, and still more preferably 1 mass % or less.

TiO₂ in the glass frit is not essential, but for the purpose of adjusting the firing temperature, the chemical durability, the thermal expansion coefficient, and the like, TiO₂ may be appropriately contained as long as the homogeneity of the crystal phase derived from the glass frit is not impaired. On the other hand, in the case where Bi₂O₃ is contained in the glass frit, Bi₂O₃ reacts with the TiO₂ component in the glass frit to precipitate a crystal of bismuth titanate, whereby the thermal expansion coefficient may be increased.

From these viewpoints, in the case where TiO₂ is contained, a content of TiO₂ in the ceramic color layer is preferably 0.1 mass % or more. On the other hand, the content of TiO₂ in the ceramic color layer is preferably 5 mass % or less, more preferably 3 mass % or less, still more preferably 1.5 mass % or less, and yet still more preferably 1 mass % or less.

CeO₂ in the glass frit is not essential, but may be contained for the purpose of adjusting the firing temperature, the thermal expansion coefficient, and the like. On the other hand, the homogeneity of the crystal phase derived from the glass frit may be impaired, and an amount of CeO₂ in the glass frit is preferably small.

From these viewpoints, a content of CeO₂ in the ceramic color layer is preferably 1 mass % or less.

The glass frit may contain, in addition to the above components, CuO, Fe₂O₃, CoO, Nb₂O₅, Ta₂O₅, Sb₂O₃, Cs₂O, P₂O₅, ZrO₂, La₂O₃, SnOₓ (X is 1 or 2), or a metal fluoride such as BiF₃, NaF, KF, LiF, MgF₂, CaF₂, SrF₂, BaF₂, AlF₃, or TiF₄ as an optional component. However, in the case where a content of the optional component is large, the glass in the glass frit becomes unstable and may devitrify. In addition, the transition point Tg and the softening point Ts of the glass may increase. Therefore, in the case where the glass frit contains these components, a total content thereof is preferably 10 mass % or less in the glass frit, and preferably 5 mass % or less in the ceramic color layer.

ZrO₂ in the ceramic color layer is not essential, but in the case of being contained as, for example, zircon which is a filler, the thermal expansion coefficient of the ceramic color layer can be reduced. On the other hand, from the viewpoint of preventing a decrease in the sinterability of the ceramic color layer and preventing crystallization by reaction with Bi₂O₃ contained in the glass frit, a content of ZrO₂ in the ceramic color layer is preferably 2 mass % or less, more preferably 1 mass % or less, and still more preferably 0.5 mass % or less. For example, ZrO₂ may be contained as a composite such as zircon, instead of ZrO₂ alone.

CuO, CrO, MnO, NiO, and CoO in the ceramic color layer are mainly pigments as coloring components, and contribute to a desired color, gloss, and opacity, that is, transmittance. In the case of the black ceramic color layer, at least one of the components constituting the pigment is preferably CuO, CrO, MnO, NiO, or CoO in order to obtain a desired black color.

From the viewpoint of obtaining a desired color tone, a total content of CuO, CrO, MnO, NiO, and CoO in the ceramic color layer is preferably 5 mass % or more, and more preferably 10 mass % or more. In addition, from the viewpoint of not impairing the sinterability of the ceramic color layer, the total content is preferably 30 mass % or less, more preferably 25 mass % or less, still more preferably 20 mass % or less, and yet still more preferably 15 mass % or less.

In addition, from the viewpoint of obtaining a good fluidity of the glass even in a low temperature range corresponding to 500° C., a total content represented by (Na₂O+K₂O+B₂O₃) in the ceramic color layer is preferably 0.1 mass % or more. On the other hand, from the viewpoint of preventing the thermal expansion coefficient from becoming extremely high, and obtaining a high peel strength after the moisture resistance test and a good releasability, the total content is preferably 5.0 mass % or less, more preferably 4.0 mass % or less, still more preferably 3.0 mass % or less, and yet still more preferably 2.0 mass % or less.

Among Na₂O, K₂O, and B₂O₃, a content of B₂O₃ in the ceramic color layer is difficult to be quantified by outermost surface analysis. Therefore, since a difference between the total content in the ceramic color layer and the total content in the ceramic color composition before firing is small, the total content in the ceramic color composition can be regarded as the total content in the ceramic color layer. Therefore, the total content represented by (Na₂O+K₂O+B₂O₃) in the ceramic color composition is also preferably within the above range.

From the viewpoint of obtaining a good moisture resistance, a content ratio represented by B₂O₃/Bi₂O₃ in the ceramic color layer is preferably 0 to 0.08, more preferably to 0.07, and still more preferably 0 to 0.04. In addition, similarly to the total content represented by (Na₂O+K₂O+B₂O₃), the content ratio represented by B₂O₃/Bi₂O₃ in the ceramic color composition can also be regarded as the ratio in the ceramic color layer. Therefore, the content ratio represented by B₂O₃/Bi₂O₃ in the ceramic color composition is also preferably within the above range.

From the viewpoint of obtaining a good solder wettability, glass strength, and weather resistance, a content ratio (mass ratio) represented by SiO₂/Bi₂O₃ in the ceramic color layer is preferably 0.3 or more, more preferably 0.35 or more, and further preferably 0.4 or more, and is preferably 1.0 or less, and more preferably 0.65 or less. The above range of the mass ratio represented by SiO₂/Bi₂O₃ is particularly suitable in the case where the conductive layer includes a crystallized region derived from the glass frit.

Although the stoichiometry of Bi₄Si₃O₁₂ is SiO₂/Bi₂O₃=0.19 in terms of mass ratio, but in the case of stoichiometry, crystals of Bi₁₂SiO₂₀ and BiSiO₅ are likely to be precipitated. Therefore, by increasing the content of SiO₂ in the ceramic color layer, the crystallinity of Bi₄Si₃O₁₂ is increased, and as a result, the solder wettability is improved, leading to improvement in glass strength and weather resistance. On the other hand, in the case where an SiO₂/Bi₂O₃ mass ratio is extremely large, the amount of Bi₂O₃ is small, and a ratio of elements other than SiO₂ and Bi₂O₃ is inevitably large. Therefore, other characteristics as the glass for a vehicle may not be satisfied.

A thickness of the ceramic color layer affects the ultraviolet transmittance, the acid resistance, the weather resistance, the glass strength, and the cost. That is, in the case where the thickness of the ceramic color layer is thin, for example, in the case where acid rain penetrates into the ceramic color layer, the black color may be discolored or the ceramic color layer may be transparent, and the ceramic color layer may not serve as the original ceramic color layer. From these viewpoints, the thickness of the ceramic color layer is preferably 5 μm or more, and more preferably 10 μm or more. In addition, in the case where the thickness of the ceramic color layer is increased, the ceramic color layer is easily affected by stress, which leads to an increase in cost. From these viewpoints, the thickness of the ceramic color layer is preferably 30 μm or less, more preferably 20 μm or less, and more preferably less than 15 μm.

As the thickness of the ceramic color layer, a value obtained by measuring a thickness of a region where the conductive layer is not formed by a cross-sectional SEM can be adopted. In addition, a value obtained by performing a step measurement using a contour shape integration measuring machine in a portion where the ceramic color layer is formed and a portion where the ceramic color layer is not formed, that is, a region of only a portion where the glass plate is formed in a region where the conductive layer is not formed may be adopted.

The conductive layer is not particularly limited as long as it contains silver, and a known conductive layer can be used.

For example, the conductive layer may consist of silver. In addition, the conductive layer may contain copper in addition to silver. In view of the influence of oxidation, a conductive layer containing silver and composed of a component that is difficult to be oxidized is more preferable.

From the viewpoint of joining to a solder, the thickness of the conductive layer after firing is preferably 4 μm or more, more preferably 6 μm or more, and still more preferably 8 μm or more. In addition, in the case where the solder wettability is taken into consideration, the solder wettability can be improved by increasing the thickness of the conductive layer as much as possible and scraping the surface layer in some cases. On the other hand, an increase in the thickness of the conductive layer causes an increase in cost, and an increase in stress due to the joining of the ceramic and the metal causes a decrease in strength. Therefore, from these viewpoints, the thickness of the conductive layer is preferably 14 μm or less, more preferably 12 μm or less, and still more preferably 10 μm or less.

As the glass plate, a known glass used for a glass for a vehicle in the related art can be used. Examples thereof include a soda lime glass, an aluminosilicate glass, a borosilicate glass, an alkali-free glass, and a quartz glass.

In addition, a laminated glass in which two or more glass plates are bonded to each other via an interlayer film may be used, and each of the glasses constituting the laminated glass may be the same or different.

A material of the interlayer film is not particularly limited, and for example, a thermoplastic resin is preferable.

Examples of the thermoplastic resin include a plasticized polyvinyl acetal resin, a plasticized polyvinyl chloride resin, a saturated polyester resin, a plasticized saturated polyester resin, a polyurethane resin, a plasticized polyurethane resin, an ethylene-vinyl acetate copolymer resin, an ethylene-ethyl acrylate copolymer resin, a cycloolefin polymer resin, and an ionomer resin. In addition, a resin composition containing a modified block copolymer hydride described in Japanese Patent No. 6065221 can also be suitably used as the material for the interlayer film.

The above thermoplastic resins may be used alone or in combination of two or more types thereof. In addition, the expression “plasticized” means that plasticization is performed by addition of a plasticizer. In addition, the material of the interlayer film may be a resin containing no plasticizer, such as an ethylene-vinyl acetate copolymer resin.

Among these, a plasticized polyvinyl acetal resin is more preferable because it is excellent in balance among various performances such as transparency, weather resistance, strength, adhesive force, penetration resistance, impact energy absorbability, moisture resistance, heat shielding property, and sound insulating property.

Examples of the polyvinyl acetal resin include a polyvinyl formal resin obtained by reacting polyvinyl alcohol (PVA) with formaldehyde, a polyvinyl acetal resin in a narrow sense obtained by reacting PVA with acetaldehyde, and a polyvinyl butyral resin (PVB) obtained by reacting PVA with n-butyl aldehyde. In particular, PVB is more preferable because it is excellent in balance among various performances such as transparency, weather resistance, strength, adhesive force, penetration resistance, impact energy absorption, moisture resistance, heat shielding property, and sound insulation property. These polyvinyl acetal resins may be used alone or in combination of two or more types thereof.

As the glass plate, a glass plate subjected to a strengthening treatment as necessary can be used. In particular, in the case where the glass for a vehicle is a window glass for an automobile and is a side glass or a rear glass, a strengthening treatment may be performed according to a required safety standard.

The strengthening treatment may be a chemical strengthening treatment or a physical strengthening treatment (air cooling strengthening treatment), but the physical strengthening treatment is preferable from the viewpoint of a strengthening treatment time and cost.

The physical strengthening treatment can reinforce the glass surface by generating a compressive stress layer on the glass surface due to a temperature difference between the glass surface and the inside of the glass. Specifically, a compressive stress layer due to a temperature difference is generated by an operation other than a slow cooling, such as a rapid cooling by spraying a cooling medium onto the glass plate heated to a softening point of the glass or higher.

The chemical strengthening treatment is a treatment in which a glass is brought into contact with a metal salt by a method such as immersing the glass in a molten solution of a metal salt containing metal ions having a large ionic radius, and metal ions having a small ionic radius in the glass are substituted with the metal ions having a large ionic radius. Typically, lithium ions are substituted with sodium ions or potassium ions, and sodium ions are substituted with potassium ions.

In the case where the chemical strengthening treatment is performed, a known molten solution of a metal salt, that is, a molten salt can be used. Conditions of the chemical strengthening treatment are appropriately selected in consideration of the glass composition, the type of the molten salt, and the like. In addition, the chemical strengthening treatment may be performed in multiple stages, or cleaning with an alkaline solution, cleaning by a plasma irradiation, or the like may be performed.

The thickness of the glass plate may be set according to the purpose, and is not particularly limited.

For example, in the case of being used for an automobile among vehicles, the thickness of the glass plate is approximately 0.2 mm to 5.0 mm, and preferably 0.3 mm to 3.0 mm.

From the viewpoint of strength such as a flying stone resistance, a thickness of a glass plate that is a laminated glass in the case of being used in an automobile, particularly in the case of being used for a windshield, and that is located on a vehicular exterior side in the case of being attached to an automobile is preferably 1.1 mm or more, and more preferably 1.8 mm or more. In addition, from the viewpoint of weight reduction of the laminated glass, the thickness of the glass plate is preferably 3.0 mm or less, and more preferably 2.8 mm or less. A thickness of a glass plate that is a laminated glass and that is located on a vehicular inner side in the case of being attached to an automobile is preferably 0.3 mm or more from the viewpoint of handleability, and is preferably 2.3 mm or less from the viewpoint of weight reduction of the laminated glass. The two glass plates used for the laminated glass may have the same or different thicknesses.

In the glass for a vehicle, the solder layer may be formed on at least a partial region of the surface of the conductive layer containing silver. The solder layer may be a leaded solder layer or a lead-free solder layer, but it is preferable that the lead-free solder layer 4 be formed as illustrated in FIG. 2 from the viewpoint of reducing an environmental load represented by an ELV directive. In addition, since the glass for a vehicle according to the present embodiment exhibits a good solder wettability, a lead-free solder layer in which a thin coating film cannot be formed by a low-melting-point solder is also preferable from the viewpoint of being able to enjoy the advantage of the effect.

Since a lead-free solder is harder than a leaded solder, a stress tends to concentrate in the case where a lead-free solder layer is formed, and weather resistance becomes a problem. However, the glass for a vehicle according to the present embodiment can cope with weather resistance without any problem.

The lead-free solder layer is a layer made of a solder having a lead (Pb) content of 0.1 mass % or less, and the Pb content is preferably 0.05 mass % or less. In addition, a content of tin (Sn) in the lead-free solder layer is preferably 95 mass % or more.

Examples of the lead-free solder layer containing Sn as a main component include layers made of a lead-free solder such as an Sn—Ag-based solder, an Sn—Ag—Cu-based solder, an Sn—Zn—Bi-based solder, an Sn—Cu-based solder, an Sn—Ag—In—Bi-based solder, an Sn—Zn—Al-based solder, an Sn—Ag—In—Cu-based solder, and an Sn—Ag—In—Cu—Zn—Ni-based solder. Among them, for example, an Sn—Ag-based solder and an Sn—Ag—Cu-based solder are preferable.

The solder wettability with respect to the glass for a vehicle is determined by the amount of the migration of the glass frit constituting the ceramic color layer to the conductive layer. In Examples to be described later, a Bi-based glass is used as the glass frit, and an Ag electrode is used as the conductive layer. All of the several types of elements migrated to the surface of the conductive layer are measured, and among them, a quantitative value of Bi which is more easily migrated and has a high concentration is adopted to determine the migration amount by the mass ratio of Bi and Ag (Bi/Ag). The Bi/Ag mass ratio in the surface of the conductive layer may be less than 0.10, and is preferably less than 0.09, more preferably 0.05 or less, still more preferably 0.04 or less, and the smaller the ratio is, the more preferable the ratio is. The content of Bi and Ag for obtaining the Bi/Ag mass ratio is a ratio of the composition (mass %) obtained by surface SEM-EDX analysis or XPS of the region where the conductive layer is formed.

In the SEM-EDX analysis, only a layer closer to the surface of the conductive layer may be analyzed by decreasing the acceleration voltage. In consideration of the thickness of the ceramic color layer, the standard of the acceleration voltage excited with a sufficient intensity is preferably 5 kV to 15 kV, and more preferably 5 kV to 10 kV. In addition, since the conductive layer is made of a metal containing Ag, at the time of quantification by the SEM-EDX analysis, mass % is quantified by each element, not in terms of oxides. In the SEM-EDX analysis performed at the time of measuring a mass concentration of O in the outermost surface of the conductive layer in order to obtain the migration amount, the acceleration voltage is also preferably in the same range as described above.

Further, as the evaluation on the solder wettability, it is also possible to perform measurement by the peel strength of the lead-free solder layer after the lead-free solder layer is adhered to the surface of the conductive layer. A correlation is obtained that the smaller the Bi/Ag mass ratio is, the higher the peel strength is.

In addition to the glass plate, the ceramic color layer, the conductive layer containing silver, and the solder layer, the glass for a vehicle may include a low-reflection film layer, a heat insulating film layer, a UV cut film layer, and the like as long as the effects of the present invention are not impaired.

The glass for a vehicle often has a curved surface for its application, and the glass plate preferably has a curved surface.

The curved surface is preferably formed by the firing bending described above. A curved surface is formed on the glass plate by heating, whereby in the case where the ceramic color layer, as a sintered layer, is more favorably joined to the glass plate, and bending can be performed simultaneously. However, it is not excluded that after the ceramic color layer and the conductive layer are formed, the firing bending is separately performed, or the ceramic color layer and the conductive layer are provided in advance on a glass plate having a curved surface.

In addition, in the case where the glass for a vehicle is a glass for an automobile, the glass plate is used to form a laminated glass, and thereby the glass for a vehicle is mainly used for a windshield for an automobile and a roof glass for an automobile. That is, the glass for a vehicle according to the present embodiment is also suitably used for a laminated glass for a windshield and a roof glass.

A 0.1% breaking strength in a Weibull plot of a static load strength at a portion where the conductive layer containing silver is formed on the surface of the ceramic color layer of the glass for a vehicle is preferably 20 MPa or more, more preferably 30 MPa or more, still more preferably 35 MPa or more, and still more preferably 40 MPa or more. The upper limit of the 0.1% breaking strength is not particularly limited, but is generally 70 MPa or less.

The 0.1% breaking strength in the Weibull plot of the static load strength is obtained by adopting a value that is a 1/1,000 strength from the Weibull plot obtained in accordance with JIS 1625 (2010).

The weather resistance at the time of joining a terminal to the glass for a vehicle via the lead-free solder layer can be determined by a tensile strength test or a heat cycle strength test after the moisture resistance test.

In the moisture resistance tensile strength test, the terminal is joined via the lead-free solder layer, and a peel strength is measured after 500 hours under the conditions of 80° C. and a humidity of 96% RH. In the case where the peel strength is 100 N or more, it can be determined that peeling in the actual market is difficult to occur and the moisture resistance is excellent. Therefore, the peel strength is preferably 100 N or more, more preferably 150 N or more, and still more preferably 200 N or more. The upper limit of the peel strength is not particularly limited.

An appearance is judged by a visual observation on a peeled interface. In the case where the peel strength is 100 N or more, the adhesive force is sufficient, and thus the terminal is forcibly peeled off with a force equal to or more than the peel strength. In this case, a cohesive failure of the ceramic color layer or peeling due to a glass plate cohesive failure mode occurs.

On the other hand, in the case where the peel strength is 100 N or less, peeling at the interface between the ceramic color layer and the conductive layer, a cohesive failure in the conductive layer, or peeling at the interface between the conductive layer and the solder layer occurs. In this case, peeling of the terminal occurs over time, and for example, in the case where the terminal is a heating wire, it means that it is difficult to cause a current to flow stably.

In the heat cycle strength test, a step of heating the glass for a vehicle joined to the terminal via the lead-free solder layer to 105° C. and then cooling the glass for a vehicle to −40° C. is defined as one cycle, and the appearance is inspected and the static load strength is measured after 60 cycles.

The property of the strength of the material with respect to the heat cycle may lead to generation of a crack or breakage as a result of repetition of stress or strain associated with the heat cycle. Therefore, in the appearance inspection, the ceramic color layer is visually observed from the glass plate side to check whether a crack or breakage occurs or not.

The static load strength after the heat cycle strength test is obtained by measuring the 0.1% breaking strength in the Weibull plot of the static load strength at the portion where the conductive layer containing silver is formed on the surface of the ceramic color layer. The 0.1% breaking strength in the Weibull plot after the heat cycle strength test is preferably 20 MPa or more, more preferably 30 MPa or more, still more preferably 35 MPa or more, and yet still more preferably 40 MPa or more. The upper limit thereof is not particularly limited, but is generally 70 MPa or less.

The 0.1% breaking strength in the Weibull plot of the static load strength is obtained by adopting a value that is a 1/1,000 strength from the Weibull plot obtained in accordance with JIS 1625 (2010).

<Method for Producing Glass for Vehicle>

The glass plate of the glass for a vehicle can be produced, or a commercially available glass plate may be used as the glass plate.

A size of the glass plate may be appropriately determined according to the application. For example, in the case where the glass for a vehicle is a windshield for an automobile, a glass plate of 500 mm to 1,300 mm×1,200 mm to 1,700 mm×1.6 mm to 2.5 mm is prepared.

The glass plate may be single, or may be a laminated glass obtained by bonding two or more glass.

The ceramic color layer is formed on at least a partial region of a surface of the glass plate.

The ceramic color layer is prepared using, as a precursor, a paste-like ceramic color composition containing the glass frit, the pigment, and various fillers as necessary.

The glass frit in the ceramic color composition is selected to have a composition satisfying the characteristics described in the above <Glass for Vehicle>. The ceramic color composition containing the glass frit, the filler, and the pigment becomes the ceramic color layer at a temperature in the vicinity of a bending molding temperature of the glass plate, that is, in a temperature range of 500° C. to 700° C. In this temperature range, bismuth silicate is used as a main crystal phase to precipitate a large amount of crystals, thereby ensuring the strength and the releasability.

Since the glass frit in the ceramic color composition exhibits various characteristics, one type of the glass frit may be used, or two or more types of glass frits may be used in combination. Further, two or more types of the glass frits having the same composition and different particle diameters may be appropriately mixed and used.

From the viewpoint of a good baking, the softening point Ts of the glass frit is preferably 500° C. or higher, and more preferably 520° C. or higher. In addition, the softening point Ts is preferably 580° C. or lower, and more preferably 540° C. or lower.

In the case where two or more types of the glass frits are used in combination, it is more preferable that one or more type of the glass frits have a softening point within the above range, and it is still more preferable that all the glass frits have a softening point within the above range.

In the case where the particle diameter D₅₀ of the glass frit is excessively small, the specific surface area becomes large, and moisture and carbon dioxide gas in the atmosphere are easily adsorbed. In this case, when the ceramic color layer is formed in a temperature range of 500° C. to 700° C., there is a possibility of foaming in the ceramic color layer and causing a decrease in transmittance, strength, and the like.

From these viewpoints, in the case where a volume-based particle size distribution curve measured by a laser diffraction scattering method exhibits bimodality, a first peak is preferably between 0.1 μm and 1.0 more preferably between 0.3 μm and 1.0 μm, still more preferably between 0.3 μm and 0.9 μm, yet still more preferably between 0.3 μm and 0.8 μm, and particularly preferably between 0.5 μm and 0.8 μm.

From the viewpoint of the sinterability, a second peak of the bimodality is preferably between 1.0 μm and 3.0 μm, more preferably between 1.0 μm and 2.5 μm, and still more preferably between 1.0 μm and 2.0 μm.

In the case where the particle size distribution of the glass frit exhibits bimodality or more as described above, the paste-like ceramic color composition may be more densely packed at the time of screen-printing the ceramic color composition, and thus is advantageous in terms of the sinterability. In order to make the particle size distribution of the glass frit to be bimodal or more, conditions for pulverizing the glass frit may be optimized, or a mixture of glass frits each having a single particle size may be used. In addition, in order to obtain a single particle size distribution, the glass frit may be classified.

The particle diameter of the glass frit is a cumulative median diameter D₅₀ of the volume-based particle size distribution and is a value measured by a laser diffraction scattering method.

From the viewpoint of preventing clogging in the case where the ceramic color composition is formed on the surface of the glass plate by screen printing, a maximum particle diameter Dₘₐₓ of the glass frit is preferably 30 μm or less, more preferably 20 μm or less, and still more preferably 15 μm or less. In addition, when the ceramic color composition is sintered, coarse particles remain melted, which may cause deterioration of the sinterability or a decrease in strength. From these viewpoints, the maximum particle diameter Dₘₐₓ of the glass frit is more preferably 10 μm or less.

From the viewpoint of obtaining a good sinterability, a content of the glass frit in the ceramic color composition is preferably 60 mass % or more, more preferably 65 mass % or more, and still more preferably 70 mass % or more. On the other hand, from the viewpoint of preventing a decrease in the strength of the glass for a vehicle due to an excessively high thermal expansion coefficient of the ceramic color layer, the content of the glass frit is preferably 90 mass % or less, more preferably 85 mass % or less, and still more preferably 80 mass % or less.

The content in the ceramic color composition in the present specification means a content in a total amount of inorganic components among components constituting the ceramic color composition, and a content of organic components is not taken into account. Therefore, the content of the glass frit in the ceramic color composition is an amount excluding a content of the filler and the pigment in the ceramic color composition.

From the viewpoint of obtaining a desired color tone, the content of the pigment in the ceramic color composition is preferably 5 mass % or more, and more preferably 10 mass % or more. In addition, from the viewpoint of not inhibiting the sinterability of the ceramic color layer, the content of the pigment is preferably 30 mass % or less, more preferably 25 mass % or less, still more preferably 20 mass % or less, and still more preferably 15 mass % or less.

Among the fillers, a content of a crystallization promoter in the ceramic color composition is preferably 0.01 mass % or more, more preferably 0.1 mass % or more, and still more preferably 1 mass % or more from the viewpoint of obtaining a good crystallinity of the glass frit. In addition, in the case where the crystallinity of the ceramic color layer is excessively high, the amount of the glass phase is excessively small, and a color tone of the ceramic color layer becomes cloudy due to diffuse reflection. Therefore, the content of the crystallization promoter is preferably 10 mass % or less, and more preferably 5 mass % or less.

The presence or absence of the crystallization promoter can be confirmed by cross-sectional analysis of the crystallized region in the obtained ceramic color layer by SEM-EDX in the case where the addition amount is large.

A powder added as the crystallization promoter is often a pulverized product, and thus remains in a crushed state in the ceramic color layer. On the other hand, the precipitated crystal has a shape such as a single needle shape, a needle shape, a plate shape, a square plate, a fan shape, or a starry shape, and thus can be distinguished from the added powder.

However, since an amount of the crystallization promoter to be actually added is small, it is difficult to determine the presence or specific content thereof from the ceramic color layer. In this case, the entire crystallized region can be regarded as the crystallized region derived from the glass frit.

In order to uniformly disperse the crystallization promoter in the entire ceramic color composition, the particle diameter D₅₀ of the crystallization promoter is preferably 2 μm or less, more preferably 1.5 μm or less, further preferably 1.0 μm or less, and still further preferably 0.8 μm or less. On the other hand, in the case where the particles are excessively atomized, the specific surface area becomes excessively large, moisture and carbon dioxide gas in the atmosphere are easily adsorbed, and transmittance, strength, and the like are decreased due to foaming in the layer at the time of forming the ceramic color layer. From the viewpoint of preventing the foaming in the layer, the particle diameter is preferably 0.02 μm or more, more preferably 0.1 μm or more, and still more preferably 0.3 μm or more.

Among the fillers, a content of the low-expansion filler in the ceramic color composition is preferably 3 mass % or more, more preferably 5 mass % or more, and still more preferably 10 mass % or more from the viewpoint of controlling the thermal expansion coefficient, a good fluidity, maintaining the strength of the glass plate, the releasability, and the like. In addition, from the viewpoint of not inhibiting the sinterability of the glass frit, the content of the low-expansion filler is preferably 30 mass % or less, more preferably 25 mass % or less, and still more preferably 20 mass % or less.

From the viewpoint of favorably maintaining the strength of the glass plate, the thermal expansion coefficient of the ceramic color composition at 50° C. to 350° C. is preferably 10⁻⁷/° C. or more, more preferably 55×10⁻⁷/° C. or more, still more preferably 60×10⁻⁷/° C. or more, and in addition, preferably 130×10⁻⁷/° C. or less, more preferably 100×10⁻⁷/° C. or less, still more preferably 85×10⁻⁷/° C. or less, and yet still more preferably 77×10⁻⁷/° C. or less.

In order to sufficiently decompose an organic vehicle, an oxidizing agent may be added as the filler. However, in consideration of a decrease in the sinterability of the ceramic color layer, a content of the oxidizing agent is preferably 10 mass % or less.

The ceramic color composition is formed into a paste by dispersing the glass frit, the pigment, and the filler as necessary, in the organic vehicle at the above ratio. The organic vehicle is a vehicle containing an organic binder, and is used for forming the ceramic color composition into a paste.

The organic vehicle is obtained by dissolving a polymer compound in a solvent. As the polymer compound and the solvent, known compounds can be used. Examples of the polymer compound include ethyl cellulose, an acrylic resin, a styrene resin, a phenol resin, and a butyral resin. Examples of the solvent include α-terpineol, butyl carbitol, butyl carbitol acetate, 2,2,4-trimethyl-1,3-pentanediol monoisobutyrate, 2,2,4-trimethyl-1,3-pentanediol diisobutyrate, ethylene glycol mono-2-ethylhexyl ether, diethylene glycol mono-2-ethylhexyl ether, ethylene glycol monohexyl ether, diethylene glycol monohexyl ether, ethylene glycol monobutyl ether acetate, and diethylene glycol monobutyl ether.

A concentration of the polymer compound in the organic vehicle is not particularly limited, but is generally 0.5 mass % to 15 mass %. In addition, in consideration of the printability during screen printing, a content of the organic vehicle containing the polymer compound in the paste-like ceramic color composition is preferably 2 mass % or more, more preferably 5 mass % or more, and still more preferably 10 mass % or more. On the other hand, in consideration of the binder removal property, the content of the organic vehicle is preferably 40 mass % or less, more preferably 30 mass % or less, and still more preferably 25 mass % or less.

The paste-like ceramic color composition is applied to at least a partial region on the surface of the glass plate.

Coating is performed by screen printing, an ink jet method, electronic printing, or the like, and the ceramic color layer is adjusted to have a desired thickness. For example, it is preferable to perform printing with a screen of a #150 mesh to a #400 mesh.

Next, the applied ceramic color composition is dried and baked on the glass plate. Drying is performed, for example, at room temperature to 200° C. for 20 minutes to 40 minutes. The baking is performed using, for example, a heating furnace such as a far-infrared (IR) heating furnace, but the baking may be performed after the conductive layer containing silver is applied to at least a partial region on the surface of the dried ceramic color composition. In addition, the firing bending of the glass may be performed simultaneously.

The conductive layer containing silver is formed by preparing a conductive paste containing silver and applying the conductive paste by screen printing, an ink jet method, electronic printing, or the like. For example, the coating is preferably performed by screen printing.

The organic vehicle to obtain a paste may be the same as the ceramic color composition.

A thickness of the conductive paste layer is, for example, 1 μm to 20 and then drying is performed at a temperature of, for example, 80° C. to 140° C. for 1 minute to 15 minutes.

A heating temperature for firing the ceramic color composition or the conductive paste layer is preferably 500° C. or higher, more preferably 590° C. or higher, and in addition, is preferably 700° C. or lower, more preferably 650° C. or lower. A heating time is preferably 3 minutes or longer, and more preferably 10 minutes or longer, and in addition, is preferably 30 minutes or shorter, and more preferably 20 minutes or shorter.

By the firing, the ceramic color composition becomes a sintered layer baked on the glass plate, and becomes the ceramic color layer containing the glass frit, the pigment, and the filler as necessary due to crystallization of at least a part of the glass frit. In addition, the conductive paste becomes the conductive layer, and the glass for a vehicle is obtained.

Heating may be performed in two or more stages, and baking and crystallization may be sequentially performed.

The overall configuration (composition) of the ceramic color layer can be measured for all elements by scraping off only the ceramic color layer from the surface or the cross section with a micro-manipulator or the like in combination with an ICP emission spectroscopy (ICP-AES) or inductively coupled plasma mass spectrometry (ICP-MS), in addition to direct analysis using fluorescent X-rays, SEM-EDX, electron probe microanalyzer (EPMA), secondary ion mass spectrometry (SIMS), or XPS.

Crystalline pigments and fillers are determined by quantitative analysis using respective standard samples by SEM-EDX or XRD, and a residue is calculated as the amount of the glass frit. Accordingly, a ratio of the glass frit, the pigment, and the filler in the ceramic color layer is obtained.

The particle diameter and particle size distribution of the filler in the ceramic color layer is obtained from a frequency distribution graph by observing a filler component with a cross section SEM-EDX and performing image analysis on the filler particle size distribution with WinROOF manufactured by MITANI CORPORATION.

In addition, although the glass composition is obtained by the above combination, thermal properties such as a softening point may also be calculated by regression calculation of the obtained glass composition.

From the viewpoint of cost, it is preferable that the firing bending be performed at the time of the above firing to obtain a glass for a vehicle in which a glass plate has a curved surface. However, the firing bending of the glass plate may be performed separately from the firing of the ceramic color layer.

In the case where the firing bending is performed at the time of the firing of the ceramic color layer, bending of the glass plate is performed while being held at the firing temperature. A heating temperature at the time of performing bending molding is preferably in the vicinity of the softening point Ts of the glass plate, and is preferably about Ts±100° C.

Examples of a method for bending the glass plate include a press bending molding in which the glass plate is heated to a temperature equal to or higher than the softening point and then the glass plate is pressed against a metal mold having a desired shape to be bent, and a gravity bending molding in which the glass plate is bent by its own weight.

From the viewpoint of making the surfaces of the ceramic color layer and the conductive layer clean and from the viewpoint of obtaining a desired shape, a press bending molding using a press device such as a heating press device is preferable. In addition, from the viewpoint of preventing a high-angle strain on an UV reflection surface, a press bending molding is also preferable.

In the gravity bending molding, the glass plate is bent by a self-weight bending device, but unlike the press bending molding, a mold having a desired shape is not required, which is advantageous in terms of cost.

The glass plate may have a single-bent shape in which the glass plate is bent and molded only in one direction, for example, only in a front-rear direction or an up-down direction of an automobile in the case of being attached to an opening of the automobile. In addition, the glass plate may have a multiple-bent shape in which the glass plate is bent and molded in a front-rear direction and an up-down direction. In the case where the glass plate is bent and molded to have a predetermined curvature and the glass plate is curved, a curvature radius of the glass plate is, for example, 1,000 mm to 100,000 mm.

In the present embodiment, the Bi/Ag mass ratio can be less than 0.10 without grinding or polishing the surface of the conductive layer, and a good solder wettability can be maintained. However, in the case where the retention is taken into consideration, from the viewpoint of obtaining a better solder wettability, the thickness of the outermost layer may be reduced by grinding or polishing the surface of the conductive layer, and the Bi/Ag mass ratio may be further reduced.

A range to be ground or polished is preferably in the range of 0 μm to 2 μm, more preferably in the range of 0 μm to 0.15 still more preferably in the range of 0 μm to 0.1 μm, and yet still more preferably in the range of 0 μm to 0.05 μm, from the surface of the conductive layer after firing. However, in order to play the role of the conductive layer, the thickness to be ground or polished is preferably 1/20 or less, more preferably 1/50 or less, and still more preferably 1/100 or less, of the thickness of the conductive layer after firing.

In order to improve the solder wettability of the glass plate after firing, it is preferable that the Bi/Ag mass ratio in the outermost surface be 0.05 or less by grinding or polishing a surface layer side in a range of 0 μm to 2 μm from the surface of the conductive layer after firing, it is more preferable that the Bi/Ag mass ratio in the outermost surface be 0.05 or less by grinding or polishing the surface layer side in a range of 0 μm to 0.5 μm from the surface of the conductive layer after firing, it is still more preferable that the Bi/Ag mass ratio in the outermost surface be 0.05 or less by grinding or polishing the surface layer side in a range of 0 μm to 0.1 μm from the surface of the conductive layer after firing, and it is yet still more preferable that the Bi/Ag mass ratio in the outermost surface be 0.05 or less by grinding or polishing the surface layer side in a range of 0 μm to 0.05 μm from the surface of the conductive layer after firing. The Bi/Ag mass ratio in the outermost surface after grinding or polishing is more preferably 0.04 or less, and the smaller the mass ratio is, the more preferable the mass ratio is. However, in order to play the role of the conductive layer, the thickness to be ground or polished is preferably 1/20 or less, more preferably 1/50 or less, and still more preferably 1/100 or less, of the thickness of the conductive layer after firing. Accordingly, metal atoms of the conductive layer extend and cover the glass phase portion in the glass frit floating on the surface, whereby the area of the glass phase portion in the glass frit decreases, and the solder wettability can be improved.

An anchoring effect can also be expected by grinding or polishing the surface layer side of the conductive layer, and the adhesive force of the solder of the conductive layer can be enhanced. At the time of grinding or polishing the conductive layer, steel wool, a sandpaper, a sand removing rubber, a polishing disk in which a grindstone is fitted in felt or sponge material, or the like can be used.

In the glass for a vehicle, the solder layer may be formed on at least a partial region of the surface of the conductive layer containing silver, and the lead-free solder layer is more preferably formed.

The lead-free solder layer is preferably formed via a flux from the viewpoint of removing a foreign matter and an oxide film on the surface of the conductive layer and achieving a good joining, and is more preferably formed via a halogen-free flux from the viewpoint of environmental protection.

The halogen-free flux is, for example, a flux having a chlorine (Cl) content of 900 ppm or less, a bromine (Br) content of 900 ppm or less, and a total content of Cl and Br of 1,500 ppm or less according to the JPCA ES01 (2003) standard. In addition, the halogen-free flux is a flux having a Cl content of 1,000 ppm or less, a Br content of 1,000 ppm or less, and a fluorine (F) content of 1,000 ppm or less according to the JEITA ET 7304 (2009) standard.

The flux may be contained in the lead-free solder in advance or may be applied separately, but is preferably separately applied from the viewpoint of the cleanliness of the surface state and the ease of wettability of the solder. The presence or absence of the flux can be visually determined in many cases.

### EXAMPLES

The present invention will be specifically described below with reference to Examples, but the present invention is not limited thereto. Example 8 is a comparative example, and Example 9 is a reference example.

### Examples 1 to 9

Glass raw materials having the compositions shown in Table 1 were blended and mixed, and melted at 1,100° C. to 1,500° C. to obtain vitrified products. Each of the obtained vitrified product was pulverized by a ball mill to obtain glass frits.

A softening point (unit:° C.) of each of the obtained glass frits was measured as a fourth inflection point by increasing the temperature to 700° C. at 10° C./min using a differential thermal analyzer (Thermo plus EV02 differential thermal balance TG-DTA8122, manufactured by Rigaku).

The particle size distribution of each of the glass frits and the fillers was measured using a particle diameter distribution analyzer (Microtrac MT3300EXII, manufactured by MicrotracBell). Measurement conditions were as follows.
Solvent: 20 mL of water
Ultrasonic dispersion for 2 minutes
Transmission, non-spherical
Particle refractive index: 1.75
Solvent refractive index: 1.33

In a volume-based particle size distribution curve measured by a laser diffraction scattering method, unimodality and bimodality were determined.

Each of the obtained glass frits was mixed together with Cu(CrMn)₂O₄ (TOMATEC manufactured by Asahi Chemical Industry Co., Ltd.) or (Co,Fe)(Ni,Cr)₂O₄ (manufactured by NITTO GANRYO KOGYO CO., LTD.), which is a pigment, a low-expansion filler, a crystallization promoter, and an oxidizing agent or a reducing agent at the ratio shown in Table 1 so that each of the obtained ceramic color layers had the composition shown in Table 2. The crystallization promoter was added in an amount of 0.1 mass % with respect to each of the obtained ceramic color layers. The oxidizing agent was added in an amount of 0.1 mass % with respect to each of the obtained ceramic color layers. In Tables 1 and 2, “—” means that the compound was not added. In addition, in Example 9, zirconium boride was used as the reducing agent and was added in an amount of 2 mass % with respect to the obtained ceramic color layer.

As the thermal expansion coefficient of each of the ceramic color compositions, an average linear thermal expansion coefficient in a range of 50° C. to 350° C. was calculated using a differential thermal dilatometer (Thermo plus EV02, lateral dilatometer TDL8411, manufactured by Rigaku). The results are shown in Table 1.

To 80 parts by mass of a mixture serving as each of the ceramic color compositions, a vehicle solution such as α-terpineol in which ethyl cellulose was dissolved was added at a ratio of 20 parts by mass, followed by kneading and uniformly dispersing by a three-roll mill to obtain paste-like ceramic color compositions each adjusted to have a desired paste viscosity.

Each of the paste-like ceramic color compositions obtained above was screen-printed on an entire surface of a soda-lime silica glass plate of 10 cm×10 cm×3.5 mm in a size of 9 cm×9 cm using a #180 mesh, followed by drying at 120° C. Next, a silver paste (silver paste manufactured by Du Pont) was screen-printed on the surface of the dried layer of each of the ceramic color compositions in a size of 3 cm×3 cm or 9 cm×9 cm, followed by drying to form conductive paste layers.

Thereafter, each of the glass plate on which the layer of the ceramic color composition and the layer of the conductive paste were formed was fired at 590° C. to 650° C. for 4 minutes or 7 minutes and cooled to room temperature. Next, each terminal was joined via a lead-free solder layer. For forming the lead-free solder layer, a lead-free solder having an Sn content of 98 mass % and an Ag content of 2 mass % was used.

As described above, each of the glass for a vehicle on which the ceramic color layer as the sintered layer, the conductive layer containing silver, and the lead-free solder layer were formed was obtained. A thickness of each of the ceramic color layers was 11 μm to 13 μm.

TABLE 1

| | | Example 1 | Example 2 | Example 3 | Example 4 | Example 5 |
|---|---|---|---|---|---|---|
| Glass frit | SiO₂ | 20.0 | 19.3 | 19.8 | 18.8 | 18.8 |
| composition | B₂O₃ | 2.0 | 2.4 | 2.4 | 2.3 | 2.3 |
| (mass %) | ZnO | — | — | — | — | — |
| | Li₂O | 1.4 | 1.1 | 1.2 | 1.1 | 1.1 |
| | Na₂O | — | — | — | — | — |
| | K₂O | 0.2 | — | — | — | — |
| | CaO | — | — | 3.2 | — | — |
| | BaO | 7.3 | — | — | 8.2 | 8.2 |
| | SrO | — | 5.7 | — | — | — |
| | Al₂O₃ | 1.1 | 1.2 | 1.2 | 1.2 | 1.2 |
| | TiO₂ | 1.3 | 0.7 | 0.7 | 0.7 | 0.7 |
| | Bi₂O₃ | 66.0 | 68.7 | 70.6 | 66.9 | 66.9 |
| | CeO₂ | 0.7 | 0.9 | 0.9 | 0.8 | 0.8 |
| | Total | 100.0 | 100.0 | 100.0 | 100.0 | 100.0 |
| Physical | Glass frit softening | 530 | 531 | 533 | 524 | 524 |
| property | point Ts (fourth | | | | | |
| | inflection point) (° C.) | | | | | |
| | Glass frit particle | Bimodal | Bimodal | Bimodal | Bimodal | Bimodal |
| | size distribution | | | | | |
| | characteristic | | | | | |
| | Glass frit particle | 0.6 | 0.6 | 0.7 | 0.6 | 0.6 |
| | size distribution peak | | | | | |
| | 1 (μm) | | | | | |
| | Glass frit particle | 1.4 | 1.5 | 1.5 | 1.3 | 1.4 |
| | size distribution peak | | | | | |
| | 2 (μm) | | | | | |
| Pigment | Pigment composition | Cu(CrMn)₂O₄ | Cu(CrMn)₂O₄ | Cu(CrMn)₂O₄ | (Co,Fe)(Ni,Cr)₂O₄ | Cu(CrMn)₂O₄ |
| Added filler | Added filler (1) | Cordierite | Cordierite | Cordierite | Spherical SiO₂ | Cordierite |
| | structure•composition | | | | | |
| | Added filler (1) | Unimodal | Unimodal | Unimodal | Unimodal | Unimodal |
| | particle size | | | | | |
| | distribution | | | | | |
| | characteristic | | | | | |
| | Added filler (2) type | Crushed SiO₂ | — | — | — | — |
| | Added filler (2) | Unimodal | — | — | — | — |
| | particle size | | | | | |
| | distribution | | | | | |
| | characteristic | | | | | |
| | Added filler (3) | Bi₄Si₃O₁₂ | Bi₄Si₃O₁₂ | Bi₄Si₃O₁₂ | Bi₄Si₃O₁₂ | Bi₄Si₃O₁₂ |
| | crystallization | 0.1% | 0.1% | 0.1% | 0.1% | 0.1% |
| | promoter | | | | | |
| | Added filler (4) | A | A | A | A | A |
| | oxidizing agent | | | | | |
| | Added filler (5) | None | None | None | None | None |
| | reducing agent | | | | | |

| | | | | | |
|---|---|---|---|---|---|
| Glass frit ratio (mass %) in | 75.0 | 75.0 | 75.0 | 79.6 | 75.0 |
| ceramic color composition | | | | | |
| Pigment ratio (mass %) in ceramic | 14.3 | 14.6 | 14.6 | 16.1 | 14.6 |
| color composition | | | | | |
| Filler ratio (mass %) in ceramic | 10.1 | 10.4 | 10.4 | 4.3 | 10.4 |
| color composition | | | | | |
| (Na₂O + K₂O + B₂O₃) (mass %) in | 1.7 | 1.8 | 1.8 | 1.8 | 1.7 |
| ceramic color composition | | | | | |
| (B₂O₃/Bi₂O₃) in ceramic color | 0.03 | 0.03 | 0.03 | 0.03 | 0.03 |
| composition | | | | | |
| Thermal expansion coefficient | 69 | 75 | 61 | 74 | 63 |
| (×10⁻⁷/° C.) of ceramic color layer | | | | | |

| | | Example 6 | Example 7 | Example 8 | Example 9 |
|---|---|---|---|---|---|
| Glass frit | SiO₂ | 25.0 | 29.3 | 28.3 | 18.8 |
| composition | B₂O₃ | 2.5 | — | 6.7 | 2.3 |
| (mass %) | ZnO | 7.2 | — | 19.2 | — |
| | Li₂O | 2.2 | 3.8 | 3.0 | 1.1 |
| | Na₂O | 1.9 | — | 2.7 | — |
| | K₂O | — | 1.7 | — | — |
| | CaO | — | — | — | — |
| | BaO | — | — | — | 8.2 |
| | SrO | — | — | — | — |
| | Al₂O₃ | — | — | — | 1.2 |
| | TiO₂ | 2.0 | 5.8 | 2.7 | 0.7 |
| | Bi₂O₃ | 58.5 | 58.8 | 35.7 | 66.9 |
| | CeO₂ | 0.7 | 0.6 | 1.7 | 0.8 |
| | Total | 100.0 | 100.0 | 100.0 | 100.0 |
| Physical | Glass frit softening | 528 | 540 | 545 | 524 |
| property | point Ts (fourth | | | | |
| | inflection point) (° C.) | | | | |
| | Glass frit particle | Bimodal | Bimodal | Unimodal | Unimodal |
| | size distribution | | | | |
| | characteristic | | | | |
| | Glass frit particle | 0.8 | 0.6 | 1.7 | 2.0 |
| | size distribution peak | | | | |
| | 1 (μm) | | | | |
| | Glass frit particle | 1.9 | 1.3 | No peak | No peak |
| | size distribution peak | | | | |
| | 2 (μm) | | | | |
| Pigment | Pigment composition | Cu(CrMn)₂O₄ | Cu(CrMn)₂O₄ | Cu(CrMn)₂O₄ | Cu(CrMn)₂O₄ |
| Added filler | Added filler (1) | Cordierite | Spherical | Cordierite | Crushed |
| | structure•composition | | SiO₂ | | Al₂O₃ |
| | Added filler (1) | Unimodal | Unimodal | Unimodal | Unimodal |
| | particle size | | | | |
| | distribution | | | | |
| | characteristic | | | | |
| | Added filler (2) type | Zircon | Cordierite | — | 9Al₂O₃—2B₂O₃ |
| | Added filler (2) | Unimodal | Unimodal | — | Needle |
| | particle size | | | | bimodal |
| | distribution | | | | |
| | characteristic | | | | |
| | Added filler (3) | Bi₄Si₃O₁₂ | Bi₄Si₃O₁₂ | Bi₄Si₃O₁₂ | None |
| | crystallization | 0.1% | 0.1% | 0.1% | |
| | promoter | | | | |
| | Added filler (4) | A | A | A | None |
| | oxidizing agent | | | | |
| | Added filler (5) | None | None | None | A |
| | reducing agent | | | | |

| | | | | |
|---|---|---|---|---|
| Glass frit ratio (mass %) in | 72.0 | 76.9 | 71.5 | 70.1 |
| ceramic color composition | | | | |
| Pigment ratio (mass %) in ceramic | 14.7 | 14.3 | 15.0 | 21.9 |
| color composition | | | | |
| Filler ratio (mass %) in ceramic | 13.3 | 8.8 | 13.5 | 8.0 |
| color composition | | | | |
| (Na₂O + K₂O + B₂O₃) (mass %) in | 3.2 | 1.3 | 6.7 | 4.1 |
| ceramic color composition | | | | |
| (B₂O₃/Bi₂O₃) in ceramic color | 0.04 | 0.00 | 0.19 | 0.09 |
| composition | | | | |
| Thermal expansion coefficient | 73 | 74 | 78 | 85 |
| (×10⁻⁷/° C.) of ceramic color layer | | | | |

TABLE 2

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Ceramic | SiO₂ | 22.3 | 20.3 | 20.6 | 19.2 | 19.9 | 25.3 | 28.0 | 27.8 | 13.2 |
| color layer | B₂O₃ | 1.5 | 1.8 | 1.8 | 1.8 | 1.7 | 1.8 | — | 4.8 | 4.1 |
| compo- | ZnO | — | — | — | — | — | 5.2 | — | 13.7 | — |
| sition | Li₂O | 1.1 | 0.8 | 0.9 | 0.9 | 0.8 | 1.6 | 2.9 | 2.1 | 0.8 |
| (mass %) | Na₂O | — | — | — | — | — | 1.4 | — | 1.9 | — |
| | K₂O | 0.1 | — | — | — | — | — | 1.3 | — | — |
| | MgO + CaO + BaO + SrO | 7.2 | 6.6 | 4.7 | 6.5 | 8.5 | 2.3 | 1.6 | 3.0 | 5.7 |
| | Al₂O₃ | 2.6 | 3.2 | 3.2 | 1.0 | 3.2 | 2.3 | 1.6 | 3.0 | 5.3 |
| | TiO₂ | 1.0 | 0.5 | 0.5 | 0.6 | 0.5 | 1.4 | 4.5 | 1.9 | 0.5 |
| | Bi₂O₃ | 49.3 | 51.5 | 53.0 | 53.3 | 50.2 | 42.0 | 45.3 | 25.6 | 46.8 |
| | CeO₂ | 0.6 | 0.7 | 0.7 | 0.6 | 0.6 | 0.5 | 0.5 | 1.2 | 0.6 |
| | ZrO₂ | | | — | — | — | 1.5 | — | — | 1.0 |
| | Cu—Cr—Mn—Co—Ni—O | 14.3 | 14.6 | 14.6 | 16.1 | 14.6 | 14.7 | 14.3 | 15.0 | 22.0 |
| | Total | 100.0 | 100.0 | 100.0 | 100.0 | 100.0 | 100.0 | 100.0 | 100.0 | 100.0 |

| | | | | | | | | | |
|---|---|---|---|---|---|---|---|---|---|
| SiO₂/Bi₂O₃ of entire ceramic color | 0.45 | 0.39 | 0.39 | 0.36 | 0.40 | 0.60 | 0.62 | 1.09 | 0.28 |
| layer in sintered substrate | | | | | | | | | |
| Precipitated crystal of entire | Bi₄Si₃O₁₂ | Bi₄Si₃O₁₂ | Bi₄Si₃O₁₂ | Bi₄Si₃O₁₂ | Bi₄Si₃O₁₂ | Bi₄Si₃O₁₂ | Bi₄Si₃O₁₂ | Bi₄Si₃O₁₂ | Bi₂SiO₅ |
| ceramic color layer in sintered | (A) | (A) | (A) | (A) | (A) | (A) | (A) | (A) | (C) |
| substrate | | | | | | | | | |
| Crystallinity (%) of entire ceramic | 40 | 16 | 20 | 38 | 41 | 52 | 42 | 6 | 9 |
| color layer in sintered substrate | | | | | | | | | |

[Evaluation]

Ratios of the glass frit, the pigment, and the filler in the ceramic color layer were confirmed to be the ratios shown in Table 1 by XRD and SEM-EDX quantitative analysis.

It was confirmed that the compositions other than B₂O₃ and Li₂O in the entire configuration of the ceramic color layer were the same as the compositions charged by SEM-EDX and quantitative analysis.

The ceramic color layer was subjected to X-ray powder diffraction measurement to identify the precipitated crystal phase. The measurement was performed under the conditions of a CuKα ray, a voltage of 40 kV, a current of 15 mA, a scan width of 0.02°, 2θ=10° to 60°, and a scanning speed of 2°/min using MiniFlex600 manufactured by Rigaku. The results are shown in Table 1, and in Examples 1 to 8, crystals of Bi₄Si₃O₁₂ were confirmed. A thermal expansion coefficient of each of the crystals is low and is 7×10⁻⁷/° C. On the other hand, in Example 9, crystals of Bi₂SiO₅ were confirmed. It is presumed that the crystals of Bi₂SiO₅ exhibit a high thermal expansion coefficient even in the case where the value of the thermal expansion coefficient is taken into consideration.

In addition, each of the crystallinities was obtained according to the equation X=I_{c}/(I_{c}+Iₐ)×100 (I_{c}: crystalline scattering integrated intensity, amorphous scattering integrated intensity), and is shown in Table 2.

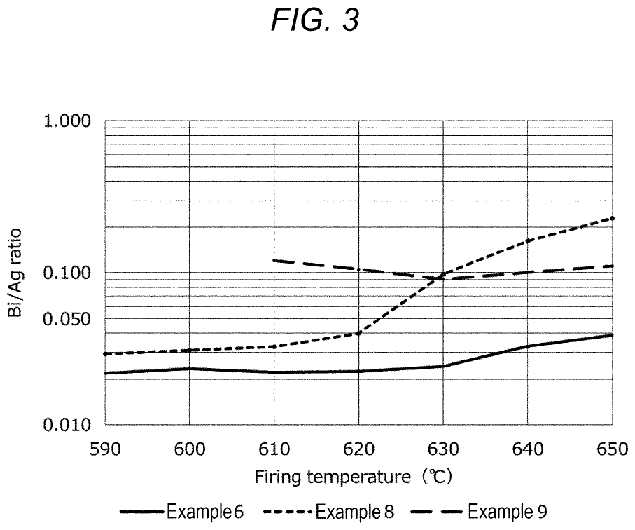

The Bi/Ag mass ratio in the outermost surface of the conductive layer containing silver after firing the glass for a vehicle in which the conductive layer was provided on the ceramic color layer at 590° C. to 650° C. was measured by SEM-EDX analysis (FE-SEM/EDX Regulus8220, manufactured by Hitachi High-Tech Corporation) under the condition of an acceleration voltage of 10 kV. The amount of elements containing Bi was quantified by performing SEM-EDX analysis from the outermost surface side of the conductive layer and the Bi/Ag mass ratio was obtained by normalizing Bi with Ag. The results are shown in Table 3. In addition, FIG. 3 shows a graph of the Bi/Ag mass ratio in the firing temperature range.

In addition, as the migration amount after firing the glass for a vehicle at 630° C., a product of a mass concentration of O (oxygen) in the outermost surface of the conductive layer containing silver and a thickness of the conductive layer containing silver was obtained. Similarly to the Bi/Ag mass ratio, the mass concentration of O (oxygen) in the outermost surface of the conductive layer containing silver was measured by SEM-EDX analysis (SEM/EDX TM4000 Plus AZtecOne, manufactured by Hitachi High-Tech Corporation) under the condition of an acceleration voltage of 15 kV. The thickness of the conductive layer containing silver was also obtained by cross-sectional SEM using the above-described device. Each of the migration amount obtained above is shown in Table 3.

Each of the Bi/Ag mass ratio shown in Table 3 indicates, with 630° C. in a firing temperature range as a representative temperature, a value in that case as well as the maximum value and an average value in the case where the firing temperature is in the temperature range of 590° C. to 650° C.

According to each of the maximum values of the Bi/Ag mass ratio in the temperature range of 590° C. to 650° C., the Bi/Ag mass ratio is less than 0.10 in the entire temperature range of 590° C. to 650° C. in each of Examples 1 to 7, which is an inventive example. On the other hand, in Example 8 which is a comparative example, the value at 630° C. was 0.10, the maximum value was 0.23, and the average value was 0.10, which are all 0.10 or more, each indicating a poor solder wettability.

More specific studies are implemented. Regarding Example 6 as one of inventive examples, the Bi/Ag mass ratio was as low as 0.04 or less in the entire temperature range of 590° C. to 650° C. On the other hand, in Example 8 which is a comparative example, the Bi/Ag mass ratio in the case where the firing temperature was 640° C. was 0.16, and the Bi/Ag mass ratio in the case where the firing temperature was 650° C. was 0.23, indicating that the solder wettability was particularly poor at a high temperature. In addition, in Example 9 which is a reference example, the Bi/Ag mass ratio in the case where the firing temperature was 630° C. was 0.09 which was less than 0.10, but the Bi/Ag mass ratio in the case where the firing temperature was 610° C. was 0.12, and the Bi/Ag mass ratio in the case where the firing temperature was 650° C. was 0.11. Not only the maximum value and the average value shown in Table 3, but also the solder wettability were poor in a low-temperature portion.

Further, when the migration amount represented by the product of the mass concentration of O (oxygen) in the outermost surface of the conductive layer and the thickness of the conductive layer shown in Table 3 was examined, it was suggested that in each of Examples 1 to 5 and 7, the migration amount was 75%·μm or less and there is a correlation with the total content of Na₂O+K₂O+B₂O₃ shown in Table 1. That is, in the case where the total content of Na₂O+K₂O+B₂O₃ is 4.0 mass % or less, the migration amount tends to decrease, and in the case where the total content is 3.0 mass % or less, the migration amount tends to decrease more remarkably.

Since the solder wettability is determined by the amount of the migration of the glass frit constituting the ceramic color layer to the conductive layer, the quality can be determined by using the Bi/Ag mass ratio in the outermost layer of the ceramic color layer as one index. On the other hand, the migration amount represented by the product can also be used as an index for determining the quality of the solder wettability. Therefore, Table 3 also shows results of the solder wettability based on the Bi/Ag mass ratio and the migration amount represented by the product.

That is, when the lead-free solder was soldered on the conductive layer, in the case where the solder was able to be easily adhered and was able to sufficiently wet and spread, the solder wettability was regarded as very good and indicated by “A”, in the case where the lead-free solder was able to be adhered but the solder was difficult to be wet and spread, the solder wettability was regarded as good and indicated by “B”, and in the case where the solder did not wet and spread at the time of being lead-freely soldered, the solder wettability was regarded as poor and indicated by “C”.

As a result, it was shown that the glass for a vehicle according to each of Examples 1 to 7 achieved a better solder wettability, and even in the case where the solder layer formed on at least a partial region of the surface of the conductive layer containing silver was a lead-free solder layer, a terminal was able to be bonded with a high strength, and in particular, the glass for a vehicle according to each of Examples 1 to 5 and 7 was remarkable. The glass for a vehicle can further prevent floating of the glass phase in the glass frit from the ceramic color layer to the surface of the conductive layer, and can suitably prevent cracking of the glass due to stress concentration and peeling of the ceramic color layer.

TABLE 3

| | | Example 1 | Example 2 | Example 3 | Example 4 | Example 5 | Example 6 | Example 7 | Example 8 | Example 9 |
|---|---|---|---|---|---|---|---|---|---|---|
| Outermost | Bi/Ag mass ratio | 0.04 | 0.04 | 0.03 | 0.03 | 0.04 | 0.03 | 0.01 | 0.10 | 0.09 |
| layer of | (630° C.) | (A) | (A) | (A) | (A) | (A) | (A) | (A) | (C) | (A) |
| ceramic | Bi/Ag mass ratio | 0.04 | 0.04 | 0.03 | 0.03 | 0.04 | 0.04 | 0.01 | 0.23 | 0.12 |
| color | (maximum value | | | | | | | | | |
| layer | at 590° C. to | | | | | | | | | |
| | 650° C.) | | | | | | | | | |
| | Bi/Ag mass ratio | 0.04 | 0.04 | 0.03 | 0.03 | 0.04 | 0.04 | 0.01 | 0.10 | 0.11 |
| | (average value at | | | | | | | | | |
| | 590° C. to 650° C.) | | | | | | | | | |
| | Bi/Ag mass ratio | A | A | A | A | A | A | A | C | C |
| | (comprehensive | | | | | | | | | |
| | determination at | | | | | | | | | |
| | 590° C. to 650° C.) | | | | | | | | | |

| | | | | | | | | | |
|---|---|---|---|---|---|---|---|---|---|
| Migration amount (% · μm) | 66 | 58 | 52 | 66 | 50 | 90 | 66 | 119 | 78 |
| Solder wettability | A | A | A | A | A | B | A | C | C |

TABLE 4

| | Example | Example | Example | Example | Example | Example | Example | Example | Example |
|---|---|---|---|---|---|---|---|---|---|
| | 1 | 2 | 3 | 4 | 5 | 6 | 7 | 8 | 9 |
| Ceramic | 22 | 22 | 22 | 22 | 22 | 22 | 22 | 21 | 21 |
| color layer | (A) | (A) | (A) | (A) | (A) | (A) | (A) | (A) | (A) |
| brightness | | | | | | | | | |
| index L* | | | | | | | | | |
| value | | | | | | | | | |
| 0.1% | 54 | 66 | 67 | 38 | 46 | 36 | 36 | 40 | 28 |
| breaking | (A) | (A) | (A) | (A) | (A) | (A) | (A) | (A) | (A) |
| strength | | | | | | | | | |
| (MPa) | | | | | | | | | |
| Peel strength | 290 | 248 | 264 | 207 | 238 | 248 | 200 | 96 | — |
| (N) after | (A) | (A) | (A) | (A) | (A) | (A) | (A) | (C) | |
| moisture | | | | | | | | | |
| resistance test | | | | | | | | | |
| Heat cycle | Appearance | Appearance | Appearance | Appearance | Appearance | Appearance | Appearance | Appearance | — |
| test | OK | OK | OK | OK | OK | OK | OK | Bad | |
| determination | A | A | A | A | A | A | A | C | |

All of the ceramic color layers were black ceramic layers, and with respect to the color tone, the brightness index L* value in a CIE 1976 (L*a*b*) color space (CIELAB) was measured according to JIS Z 8722 (2000). As a color difference meter, CR-400 manufactured by Konica Minolta was used, and the measurement was performed by setting a light source to a CIE standard light source D65, an illumination and reception method to condition a ((45−n)[45−0]), and a measurement diameter to 3 mm. The results are shown in Table 4, and since the L* value is preferably in the range of 20 to 25, each of the values in the range of 20 to 25 was indicated by “A”.

A static load strength of the glass for a vehicle was measured by a ring-on-ring at a compression rate of 1 mm/min using a general-purpose compression tester. A Weibull plot was performed in accordance with JIS 1625 (2010) to obtain a 0.1% breaking strength which was a 1/1,000strength. The results are shown in Table 4.

In the glass for a vehicle in which the conductive layer is formed on the ceramic color layer, the 0.1% breaking strength in the Weibull plot of the static load strength is preferably 20 MPa or more. Therefore, in the case where the 0.1% breaking strength was 20 MPa or more, the 0.1% breaking strength was indicated by “A”, but is more preferably 30 MPa or more, and the higher the 0.1% breaking strength is, the better the 0.1% breaking strength.

The glass for a vehicle according to each of Examples 1 to 9 to which the terminal was joined was placed under the conditions of 80° C. and a humidity of 96% RH for 500 hours, and then the terminal was vertically pulled using a general-purpose tensile compression tester manufactured by SHIMADZU, and a value at the time of peeling was obtained as a peel strength of the terminal. The results are shown in “Peel strength after moisture resistance test” in Table 4. In addition, in Example 9, the solder wettability of the lead-free solder and the breaking strength in the Weibull plot were low, and the peel strength was not able to be measured well, and thus was indicated by “—”.

A step of heating the glass for a vehicle according to each of Examples 1 to 9 to which the terminal was joined to 105° C. and then cooling the glass for a vehicle to −40° C. was set as one cycle, and a visual inspection was performed and a peel strength were measured after 60 cycles.

Results are shown in “Determination of heat cycle test” in Table 4. In addition, in Example 9, the solder wettability of the lead-free solder and the 0.1% breaking strength in the Weibull plot were low, and the peel strength was not able to be measured well, and thus was indicated by “—”.

In the case where the peel strength after the moisture resistance test was 100 N or more, the peel strength was evaluated as “A”, and in the case where the peel strength was less than 100 N, the peel strength was evaluated as “C”. In addition, with respect to the glass for a vehicle after the heat cycle test, in the case where there was no visual change in the appearance, the appearance was evaluated as “A”, and in the case where there was a change in the appearance such as a crack, the appearance was evaluated as “C”.

Table 5 shows each of the compositions of the surface of the ceramic color layer after the moisture resistance test for the glass for a vehicle in which the conductive layer was formed on the ceramic color layer. The peeling interface after the moisture resistance test is the interface between the ceramic color layer and the conductive layer, and it is originally necessary to determine the interface concentration. However, in a region of about hundreds of micro meters from an end of the conductive layer of a region of the ceramic color layer where the conductive layer is not formed, the migration to both sides occurs. Therefore, the composition can be regarded as the same as the composition of the outermost surface of the ceramic color layer on which the conductive layer is not formed. Therefore, the quality of a concentration of a hydrophilic component at the interface between the ceramic color layer and the conductive layer can be determined by analyzing the composition of the outermost surface of the ceramic color layer in a region within hundreds of micro meters from the end of the conductive layer.

Therefore, Table 5 shows the compositions each measured by SEM-EDX with respect to the portion of the ceramic color layer on which the conductive layer was not formed, and which is 50 μm away from the end of the conductive layer. The compositions are expressed by mass % based on oxides. In addition, blanks in Table 5 indicate that each of the content was less than a detection limit.

Although boron (B) is not described in Table 5, it does not mean that B is not contained, but means that quantification was difficult and thus measurement was not performed. Since B is a light element, a count number of an EDX detector decreases, and the reliability of the quantitative analysis value decreases. Therefore, elements after oxygen (O) in the periodic table were quantified. It is generally possible to quantify B in XPS, but it is difficult to quantify B in this system even when XPS is used because a peak of a Binding Energy (B1s: 180 eV) of boron oxide and a peak of a Binding Energy (Ba 4p_{3/2}: (180 eV) of barium oxide overlap with each other.

TABLE 5

| | | Example 1 | Example 2 | Example 3 | Example 4 | Example 5 | Example 6 | Example 7 | Example 8 |
|---|---|---|---|---|---|---|---|---|---|
| Outermost | Bi₂O₃ | 52.3 | 59.7 | 58.2 | 55.7 | 52.7 | 47.1 | 49.1 | 28.6 |
| layer | SiO₂ | 17.2 | 17.5 | 17.4 | 18.8 | 16.4 | 21.8 | 23.1 | 24.2 |
| composition | Cr₂O₃ | 9.8 | 9.1 | 9.0 | 7.9 | 9.9 | 8.5 | 9.0 | 9.0 |
| (mass %) of | CuO | 5.1 | 4.8 | 4.5 | 4.6 | 5.1 | 4.1 | 5.4 | 5.0 |
| ceramic color | MnO₂ | 4.5 | 4.0 | 4.0 | 3.5 | 4.5 | 3.8 | 4.1 | 4.1 |
| layer | Al₂O₃ | 2.7 | 2.7 | 2.9 | 1.3 | 3.0 | 3.0 | 0.7 | 2.7 |
| | MgO | 0.9 | 0.7 | 0.8 | | 1.0 | 1.3 | | 1.1 |
| | CaO | 0.1 | 0.2 | 2.4 | | 0.1 | | | |
| | BaO | 6.5 | 0.4 | 0.3 | 7.1 | 7.3 | | | |
| | Na₂O | | 0.4 | | 1.0 | | 2.0 | 3.0 | 6.4 |
| | K₂O | | | | | | | 1.3 | |
| | TiO₂ | | 0.5 | 0.6 | | | 2.1 | 4.4 | 2.1 |
| | ZnO | | | | | | 6.5 | | 16.6 |
| | (Na₂O + K₂O)/Bi₂O₃ | 0.00 | 0.01 | 0.00 | 0.02 | 0.00 | 0.09 | 0.09 | 0.22 |

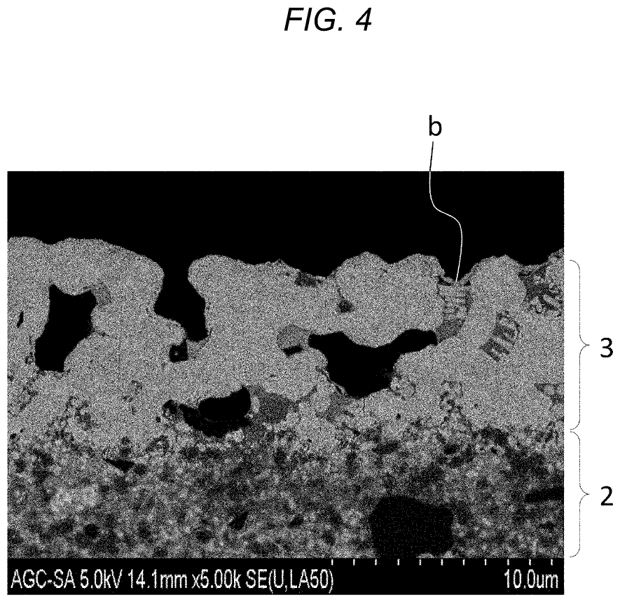

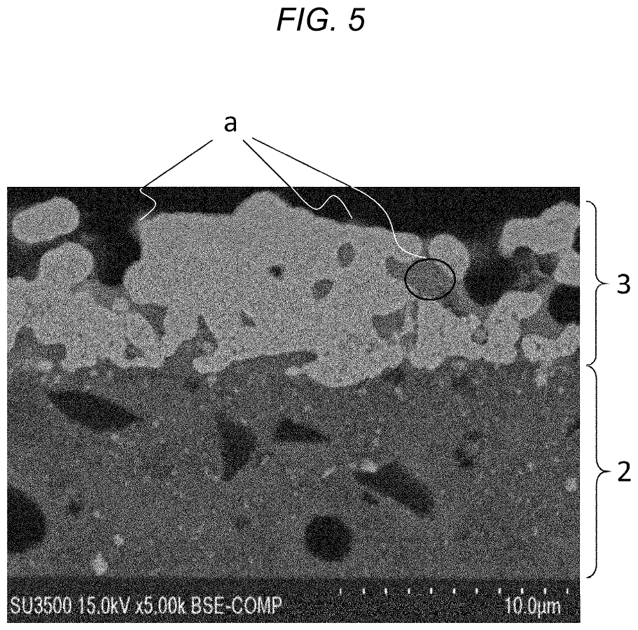

A cross section of the glass for a vehicle according to each of Examples 5 and 8 was observed with a scanning microscope (FE-SEM/EDX Regulus8220, manufactured by Hitachi High-Tech Corporation, SEM/EDX SU3500, manufactured by Hitachi High-Tech Corporation). The SEM image of Example 5 is shown in FIG. 4, and the SEM image of Example 8 is shown in FIG. 5.

In FIG. 4, a small amount of a glass phase a which was a residual glass migrated from a ceramic color layer 2 to a conductive layer 3 containing silver, but many voids remained in the conductive layer 3, and it can be seen from the cross-sectional SEM image that the amount of the migration was small. Further, a crystallized region b derived from the glass frit was confirmed in the vicinity of the surface of the conductive layer 3 containing silver, and the glass phase was difficult to be confirmed on the outermost surface.

On the other hand, in FIG. 5, a large amount of a glass phase a which was a residual glass migrated from a ceramic color layer 2 to a conductive layer 3 containing silver. Voids in the conductive layer 3 were also reduced, and it can be seen from the cross-sectional SEM image that the amount of the migration was large. The glass phase a in FIG. 5 was surrounded by a lead wire or a circle for the sake of understanding. That is, the glass phase a is a part of the glass phase migrated to the conductive layer, and does not represent the entire glass phase. Further, the crystallized region as shown in FIG. 4 was not observed on the surface of the conductive layer 3 containing silver, and many amorphous glass phases a were observed on the outermost surface thereof.

This shows that, in the process of forming the ceramic color layer and the conductive layer, the glass frit contained in the ceramic color composition or the ceramic color layer is not crystallized but largely migrates to the conductive layer as the glass phase.

In this way, in the case where the glass frit migrates as the glass phase, the Bi/Ag mass ratio in the outermost surface of the conductive layer increases, and the solder wettability decreases.

On the other hand, in the present invention, it is found that the Bi/Ag mass ratio in the outermost surface of the conductive layer can be reduced by preventing the migration as the glass phase, and a good solder wettability can be achieved.

Although the present invention has been described in detail with reference to specific embodiments, it is apparent to those skilled in the art that various changes and modifications can be made without departing from the spirit and scope of the present invention. The present application is based on Japanese patent application No. 2021-025595 filed on Feb. 19, 2021, and the contents thereof are incorporated herein by reference.

### REFERENCE SIGNS LIST

1: glass plate
2: ceramic color layer
3: conductive layer
4: lead-free solder layer
glass for a vehicle
a: glass phase
b: crystallized region

What is claimed is:

1. A glass for a vehicle, comprising:
a glass plate;
a ceramic color layer formed on a surface of the glass plate; and
a conductive layer formed on a surface of the ceramic color layer, the conductive layer comprising silver, wherein
the ceramic color layer is a sintered layer comprising a glass frit and a pigment,
the glass frit comprises Bi,
a lead-free solder layer is formed on at least a partial region of a surface of the conductive layer comprising silver, and
a Bi/Ag mass ratio in an outermost surface of the conductive layer comprising silver is less than 0.10.

2. The glass for a vehicle according to claim 1, wherein a migration amount represented by a product of a mass concentration of oxygen (O) in the outermost surface of the conductive layer comprising silver and a thickness of the conductive layer comprising silver is 75%·μm or less.

3. The glass for a vehicle according to claim 1, wherein the conductive layer comprising silver comprises a crystallized region derived from the glass frit.

4. The glass for a vehicle according to claim 1, wherein an SiO₂/Bi₂O₃ mass ratio in the ceramic color layer is 0.3 to 1.0.

5. The glass for a vehicle according to claim 1, wherein the ceramic color layer further comprises a filler.

6. The glass for a vehicle according to claim 5, wherein the filler comprises at least one selected from the group consisting of cordierite, zircon, and silica.

7. The glass for a vehicle according to claim 1, wherein the ceramic color layer has a thickness of less than 15 μm, and
contents of Na₂O, K₂O, and Bi₂O₃ satisfy a relation of {(Na₂O+K₂O)/Bi₂O₃}<0.20 in an outermost surface of the ceramic color layer after a moisture resistance test performed under conditions of 80° C. and a humidity of 96% RH for 500 hours.

8. The glass for a vehicle according to claim 1, wherein the ceramic color layer has a thermal expansion coefficient at 50° C. to 350° C. of 60×10⁻⁷/° C. to 77×10⁻⁷/° C.

9. The glass for a vehicle according to claim 1, wherein the glass frit has a softening point Ts of 500° C. to 580° C.

10. The glass for a vehicle according to claim 1, wherein a 0.1% breaking strength in a Weibull plot of a static load strength is 20 MPa or more.

11. The glass for a vehicle according to claim 10, wherein a terminal joined via the lead-free solder layer has a peel strength of 100 N or more after a moisture resistance test performed under conditions of 80° C. and a humidity of 96% RH for 500 hours.

12. The glass for a vehicle according to claim 1, wherein the lead-free solder layer comprises 95 mass % or more of Sn.

13. The glass for a vehicle according to claim 1, wherein the lead-free solder layer is formed via a halogen-free flux.

14. The glass for a vehicle according to claim 1, wherein the ceramic color layer comprises, in terms of mass % based on oxides,
15% to 30% of SiO₂,
30% to 55% of Bi₂O₃,
0% to 4% of B₂O₃,
1% to 4% of Al₂O₃,
0% to 3% of Li₂O,
0% to 1.8% of Na₂O+K₂O,
1% to 10% of MgO+CaO+BaO+SrO,
0% to 10% of ZnO,
0% to 5% of TiO₂,
0% to 1% of CeO₂,
0% to 2% of ZrO₂, and
10% to 20% of CuO+CrO+MnO+NiO+CoO, and
contents of components in the ceramic color layer satisfy the following relationships of:
0.1%≤Na₂O+K₂O+B₂O₃≤4.0%,
0≤B₂O₃/Bi₂O₃≤0.08, and
0.3≤SiO₂/Bi₂O₃≤1.0.

15. The glass for a vehicle according to claim 1, being used for a laminated glass for a windshield.
